(19) United States
(12) Patent Application Publication
(10) Pub. No.: US 2021/0372637 A1
(43) Pub. Date: Dec. 2, 2021

(54) Methods and Systems for Air Management to Reduce or Block Exposure to Airborne Pathogens

(71) Applicants: Virender K. Sharma, Paradise Valley, AZ (US); Kunal M. Sharma, Paradise Valley, AZ (US)

(72) Inventors: Virender K. Sharma, Paradise Valley, AZ (US); Kunal M. Sharma, Paradise Valley, AZ (US)

(21) Appl. No.: 17/336,896

(22) Filed: Jun. 2, 2021

Related U.S. Application Data
(60) Provisional application No. 63/173,131, filed on Apr. 9, 2021.
(60) Provisional application No. 63/152,267, filed on Feb. 22, 2021.
(60) Provisional application No. 63/062,591, filed on Aug. 7, 2020.
(60) Provisional application No. 63/033,753, filed on Jun. 2, 2020.

(51) Int. Cl. F24F 3/16; F24F 8/22; B01D 46/10

(52) U.S. Cl. CPC F24F 3/16; B01D 2273/30; B01D 46/10; F24F 8/22

(57) ABSTRACT

The present specification described a room air management system for reducing or preventing exposure to and inhalation of infected aerosol to individuals in a room, which employs filtration, purification, and sterilization techniques using physical filtration, UV sterilization, and/or photocatalytic filtration. In embodiments, the systems of the present specification may be of different sizes to accommodate differently-sized rooms. In embodiments, the system of the present specification is a stand-alone unit. In embodiments, the system of the present specification is a wall mountable air handler unit. In embodiments, the system of the present specification provides UV-C exposure to air and is capable of killing virus particles. The system of the present specification is designed such that it is user-friendly and easy to operate.

### CROSS-REFERENCE

The present application relies on U.S. Patent Provisional Application No. 63/033,753, titled “Methods and Systems for Air Management to Reduce or Block Exposure to Airborne Pathogens” and filed on Jun. 2, 2020, for priority.

The present application also relies on U.S. Patent Provisional Application No. 63/062,591, titled “Methods and Systems for Air Management to Reduce or Block Exposure to Airborne Pathogens” and filed on Aug. 7, 2020, for priority.

The present application also relies on U.S. Patent Provisional Application No. 63/152,267, titled “Methods and Systems for Air Management to Reduce or Block Exposure to Airborne Pathogens” and filed on Feb. 22, 2021, for priority.

The present application also relies on U.S. Patent Provisional Application No. 63/173,131, titled “Methods and Systems for Air Management to Reduce or Block Exposure to Airborne Pathogens” and filed on Apr. 9, 2021, for priority.

The above-mentioned applications are herein incorporated by reference in their entirety.

### FIELD

The present specification relates generally to the field of airborne pathogen and infection management. More specifically, the present specification relates to a room air management system that provides various filtration methods for reducing the level of infectious or noxious pathogens in ambient air and thus, reducing the risk of contracting viral or infectious disease or otherwise compromising immunity from inhalation of infected ambient air.

### BACKGROUND

Reducing airborne infections may be accomplished by reducing or killing infectious agents carried in the air and/or by effective air exposure and air quality management. It is common practice in surgical settings, and when dealing with infectious disease, to manage air quality. Methods include filtration, where the pore size of the filter is smaller than the pathogen, exposure to short wavelength ultraviolet-C (UV-C) light, and by generating ozone and with other chemicals. The air must be breathable after the treatment process. Pathogens include viruses, bacteria, spores, yeast, mold, fungi and other bio-hazards. Of current interest is improving air quality, via a personal air management system, to curb transmission of, among other viruses, coronaviruses and, in particular, SARS-CoV-2 which is the virus responsible for causing COVID-19 in human patients and animals. According to the United States Center for Disease Control, the incubation period is estimated at approximately 5 days, with a wider range of 2-14 days being possible. Frequently reported signs and symptoms include fever, cough, fatigue or myalgia, and shortness of breath. Less commonly reported symptoms include sputum production, headache, hemoptysis, and diarrhea. Some patients have experienced gastrointestinal symptoms such as diarrhea and nausea prior to developing fever and lower respiratory tract signs and symptoms. For certain populations, particularly patients who are 60 years old and older, COVID-19 can be fatal, with mortality rates among certain populations being as high as 20%.

Typical viral particle size ranges from 0.05 to 0.2 microns for coronavirus, 0.5 microns for bacillus, ranges from 0.3 microns to 2 microns for tuberculosis, ranges from 1 to 4 microns for anthrax, and up to 1 micron for black mold spores. Good filters (HEPA, tight fitting masks, etc.) filter out large particles and 95% of particles as small as 0.3 micron. Filter masks are effective for tuberculosis and other bacterial infections. They are less effective for viruses which are 10 times smaller in diameter than most bacteria. Extremely fine mesh filters also have pressure drops that necessitate a pump to assist the airflow. Using a high efficiency (HE) filter they claim removal of 99.97% of 0.3 mm particles (laboratory testing).

There are typically three modes of transmission of pathogens and contaminants, and in particular, infections associated with respiratory virus—fomite, droplet, and aerosol. Droplet transmission refers to exposure to larger droplets, smaller droplets, and particles (typically on the order of 5 μm to 10 μm or larger) when a person is close to an infectious source, such as an infected person. Aerosol is used to define both respiratory droplets of a certain size and the collection or cloud of these respiratory droplets in the air. Aerosol transmission consists of exposure to smaller droplets and particles (typically on the order of 5 μm and smaller) at greater distances or over longer times. Particles that are 5 μm or smaller in size can remain airborne indefinitely under most indoor conditions unless there is removal due to air currents or dilution ventilation. For example, COVID-19 aerosol transmission may occur when aerosols are emitted by a person infected with coronavirus, even one with no symptoms, when that person talks, breathes, coughs or sneezes. Another person may breathe in these aerosols and become infected with the virus. According to some studies, aerosolized coronavirus can remain in the air for up to three hours. On the other hand, droplet transmission is infection spread through exposure to virus-containing respiratory droplets (i.e. larger and smaller droplets and particles) exhaled by an infectious person. Transmission is more likely to occur when someone is in close proximity to the infectious person, and typically, within about six feet.

In a study published in 2013, data was collected using a non-invasive, visualization approach to the airflow dynamics of sneezing and breathing in healthy human volunteers. The study also made a direct comparison between maximum cough and sneeze velocities using a shadowgraph method, which, surprisingly, shows them to be firstly, quite similar in speed, and secondly, that this speed is not extremely high, as has been inferred in some older estimates of sneeze velocity. FIG. 1, FIG. 2, FIG. 3, and FIG. 4 show results of the 2013 study.

FIG. 1 shows two graphs depicting mouth breathing air flow parameters for potential particle transmission. Graph 101 shows a time vs. visible propagation distance and time vs. velocity plot, correlating the time it takes for air and/or airborne particles to travel a distance when propagated from a person's mouth and the velocity at which such air flows. Graph 102 shows a time versus 2D projected area plot and a time versus 2D projected area expansion rate plot showing the time and velocity it takes for air to flow from a person's mouth to propagate into a 2D projected area.

FIG. 2 shows two graphs depicting nasal breathing air flow parameters for potential particle transmission. Graph 201 shows a time vs. visible propagation distance and time vs. velocity plot, correlating the time it takes for air and/or airborne particles to travel a distance when propagated from a person's nose and the velocity at which such air flows. Graph 202 shows a time versus 2D projected area plot and a time versus 2D projected area expansion rate plot showing the time and velocity it takes for air to flow from a person's nose to propagate into a 2D projected area.

FIG. 3 shows two graphs depicting sneezing air flow parameters for potential particle transmission. Graph 301 shows a time vs. visible propagation distance and time vs. velocity plot, correlating the time it takes for air and/or airborne particles to travel a distance when propagated from a person's sneeze and the velocity at which such air flows. Graph 302 shows a time versus 2D projected area plot and a time versus 2D projected area expansion rate plot showing the time and velocity it takes for air to flow from a person's sneeze to propagate into a 2D projected area.

FIG. 4 shows two graphs depicting coughing air flow parameters for potential particle transmission. Graph 401 shows a time vs. visible propagation distance and time vs. velocity plot, correlating the time it takes for air and/or airborne particles to travel a distance when propagated from a person's cough and the velocity at which such air flows. Graph 302 shows a time versus 2D projected area plot and a time versus 2D projected area expansion rate plot showing the time and velocity it takes for air to flow from a person's cough to propagate into a 2D projected area.

While the human respiratory system is efficient at removing some aerosols, if they fall within particular size ranges, are highly concentrated, or toxic or pathogenic, they can cause adverse health effects.

Given the parameters above and the potential for airborne and droplet pathogens and contaminants, what is needed is a room air filtration and purification system that can reliably filter out or eliminate airborne and droplet pathogens such as viruses and infectious particles. In particular, what is needed is a room air management system that effectively employs filtration, purification, disinfection, and sterilization techniques using physical filtration, UV purification, and/or photocatalytic filtration.

### SUMMARY

The following embodiments and aspects thereof are described and illustrated in conjunction with systems, tools and methods, which are meant to be exemplary and illustrative, and not limiting in scope. The present application discloses numerous embodiments.

In some embodiments, the present specification is directed towards an air cleaning system configured to reduce human exposure to airborne pathogens, comprising: a housing, wherein the housing is adapted to be hung on a wall at a height from a floor at a base of the wall to a bottom of a housing and wherein the height is in a range of 1.5 feet to 4.5 feet; an air inlet formed within an exterior surface the housing, wherein the air inlet is formed proximate either a top of the housing or a bottom of the housing; at least one first filter positioned in the housing behind the air inlet; an air outlet formed within the housing, wherein the air outlet is formed opposite the air inlet proximate either the bottom of the housing or the top of the housing and wherein the area in the housing between the air inlet and the air outlet forms a central chamber having a left portion, middle portion, and right portion; at least one second filter positioned in the housing behind the air outlet; a first fan positioned in the left portion of the central chamber, wherein blades of the first fan are configured to rotate in a vertical plane parallel to the wall; a second fan positioned in the right portion of the central chamber, wherein blades of the second fan are configured to rotate in a vertical plane parallel to the wall; and at least one ultraviolet light source positioned within the housing.

Optionally, the housing has a total thickness defined by a distance between a first exterior surface positioned against the wall and a second exterior surface of the housing running parallel to the wall and wherein the distance is in a range of 4 inches to 12 inches.

Optionally, a height of the housing is in a range of 18 inches to 60 inches and a width of the housing is in a range of 18 inches to 60 inches.

Optionally, the air inlet comprises a plurality of openings in the housing and wherein the plurality of openings extend upward from a bottom of the housing and cover no more than 50% of the height of the housing.

Optionally, the air outlet comprises a plurality of openings in the housing and wherein the plurality of openings extend downward from a top of the housing and cover no more than 50% of the height of the housing.

Optionally, each of the first fan and the second fan is configured to generate an air flow rate ranging from 100 to 5000 cubic feet per minute.

Optionally, the blades of the first fan are configured to rotate counterclockwise and wherein, concurrently, the blades of the second fan are configured to rotate clockwise.

Optionally, the blades of the first fan are configured to rotate clockwise and wherein, concurrently, the blades of the second fan are configured to rotate counterclockwise.

Optionally, the blades of the first fan are configured to rotate clockwise and wherein, concurrently, the blades of the second fan are configured to rotate clockwise.

Optionally, the blades of the first fan are configured to rotate counterclockwise and wherein, concurrently, the blades of the second fan are configured to rotate counterclockwise.

Optionally, the at least one first filter positioned in the housing behind the air inlet comprises at least one of a particulate filter, a carbon activated filter, or a photocatalytic filter.

Optionally, the at least one first filter positioned in the housing behind the air inlet comprises a photocatalytic filter, a particulate filter positioned downstream from the photocatalytic filter and a carbon activated filter positioned downstream from the photocatalytic filter.

Optionally, the at least one first filter positioned in the housing behind the air inlet is positioned upstream of each of the first fan and the second fan.

Optionally, the at least one second filter positioned in the housing behind the air outlet comprises at least one of a particulate filter or a carbon activated filter.

Optionally, the air cleaning system further comprises an ion generator positioned downstream of the at least one particulate filter or the carbon activated filter.

Optionally, the at least one second filter positioned in the housing behind the air outlet comprises a particulate filter and a carbon activated filter positioned downstream from each of the first fan and the second fan.

Optionally, an area within the housing of the air cleaning system, behind the air outlet, and above the central chamber defines a top chamber and wherein the at least one ultraviolet light source is positioned in the top chamber such that air flowing through the top chamber is exposed to ultraviolet light.

Optionally, an internal surface of the top chamber comprises a reflective surface.

Optionally, the at least one ultraviolet light source is positioned in the top chamber such that a dose of ultraviolet light being delivered to a surface of the air flowing through the top chamber is greater than a dose of ultraviolet light being delivered to a surface of the particulate filter or the carbon activated filter.

Optionally, an ultraviolet dose for air is less than 0.05 W/cm².

Optionally, at least one of the first fan or the second fan is a backward curved centrifugal fan.

Optionally, when operated, the air cleaning system is adapted to purify, sterilize, sanitize, treat, or disinfect air in a room having a volume ranging from 100 to 50,000 cubic feet at an air flow rate ranging from 100 to 3000 cubic feet per minute (CFM), wherein an air exchange rate ranges from 5 to 20 air exchanges per hour and is calculated as 60 times the CFM divided by the volume of the room.

Optionally, a total weight of the air cleaning system is less than 100 lbs.

Optionally, a dwell time for air entering the air cleaning system and then leaving the air cleaning system is less than 1 second.

Optionally, the at least one ultraviolet light source is configured to expose an infected bioaerosol particle in the air with a first dose D1 for a first time T1, and an aerosol particle trapped on at least one of the at least one first filter and the at least one second filter, with a second dose D2 for a second time T2, wherein the first dose D1 is greater the second dose D2, the first time T1 is less that the second time T2, and a first product of the first dose D1 and the first time T1 is less a second product of the second dose D2 and the second time T2.

Optionally, the at least one ultraviolet light source is configured to expose particles trapped in at least one of the at least one first filter and the at least one second filter to a first dose per second.

Optionally, the at least one ultraviolet light source is configured to expose airborne particles to a second dose per second, wherein the first dose per second is less than 50% of the second dose per second.

In some embodiments, the present specification discloses a method for filtering, purifying, disinfecting, and/or sterilizing air in a volume to reduce or prevent exposure to and inhalation of aerosol or droplet pathogens to individuals in a room, comprising: receiving air via an air inlet, positioned in a first chamber of a housing; optionally routing the received air through a first ionizer, positioned in the first chamber of the housing; filtering the ionized air using a dust filter, positioned in the first chamber of the housing; optionally, treating the filtered air, using a first light source, positioned in a second chamber of the housing, for a first predetermined time period at a first dosage; filtering the light treated air using a first photocatalytic filter, positioned in the second chamber of the housing; optionally routing the filtered air, using one or more fans, to a second light source, wherein the second light source is positioned in a third chamber of the housing; optionally treating the filtered air, using the second light source, for a second predetermined time period at a second dosage; filtering the light treated air using a second photocatalytic filter, positioned in the third chamber of the housing; optionally treating the filtered air with a second ionizer, positioned in the third chamber of the housing; passing the ionized air through an outlet filter, positioned in a fourth chamber of the housing; optionally treating the filtered air with a third ionizer, wherein the third ionizer is positioned in the fourth chamber of the housing; delivering treated air to a volume via an air outlet.

Optionally, each of the optional first ionizer, optional second ionizer, and optional third ionizer generates ions using ion emitters comprised of carbon fibers.

Optionally, the dust filter is a MERV 7 or higher filter.

Optionally, the dust filter is a pleated filter and wherein each pleat has a dimension ranging from 1 to 4 inches.

Optionally, each of the first light source and the second light source is a UV-C light.

Optionally, each of the first light source and the second light source operates at a wavelength ranging from 100 nm to 400 nm.

Optionally, the first dosage and the second dosage ranges from 0.5 mJ/cm² to 50 mJ/cm².

Optionally, the first predetermined time period and the second predetermined time period is at least one millisecond.

Optionally, the first light source and second light source are housed within a chamber and wherein said chamber is coated with a reflective coating.

Optionally, the photocatalytic filter is a PCO/PECO filter which is activated by a UV light source and employed to destroy residual pathogens.

Optionally, the outlet filter is a filter with a rating of less than or equal to MERV 16.

Optionally, any one of the dust filter or the outlet filter may include an activated charcoal or carbon filter.

Optionally, the one or more fans is a backward curved centrifugal fan.

Optionally, the backward curved centrifugal fan is housed within a shroud.

Optionally, the backward centrifugal fan generates less than 80 dB of noise when operating at an air flow rate of 1200 cubic feet/minute (CFM) in a volume of less than or equal to 1800 cubic inches.

Optionally, the backward centrifugal fan generates less than 75 dB of noise when operating at an air flow rate of 600 cubic feet/minute (CFM) in a volume of less than 1400 cubic inches.

Optionally, the backward centrifugal fan generates less than 65 dB of noise when operating at an air flow rate of 300 cubic feet/minute (CFM) in a volume of less than or equal to 1000 cubic inches.

Optionally, two fans are employed and rotate in opposite directions to create a non-linear, turbulent air flow.

In some embodiments, the present specification is directed towards a method for filtering, purifying, disinfecting, and/or sterilizing air in a volume to reduce or prevent exposure to and inhalation of aerosol or droplet pathogens to individuals in a room, comprising: receiving air via an air inlet; filtering the received air using a dust filter; treating the filtered air, using a first light source, for a predetermined time period; routing the light treated air, using a high flow air pump, to a second light source; treating the light treated air, using the second light source, for a predetermined time period; passing the light treated air through a filter; and, delivering treated air to a volume via an air outlet.

Optionally, after receiving air via an air inlet, the received air is routed through a first ionizer.

Optionally, the resultant air after treatment with a first light source is filtered using a photocatalytic filter.

Optionally, the resultant air after treatment with a second light source is filtered using a photocatalytic filter.

Optionally, the filtered air is passed through a second ionizer.

Optionally, after passing the air through a filter, the air is treated using a third ionizer.

In some embodiments, the present specification discloses a method for filtering, purifying, disinfecting, and/or sterilizing air in a volume to reduce or prevent exposure to and inhalation of aerosol or droplet pathogens to individuals in a room, comprising: receiving air via an air inlet; filtering the received air using a dust filter, wherein said dust filter is a low efficiency filter having a rating of less than or equal to MERV 11; routing the filtered air, using at least one fan, to a light source; treating the filtered air, using a light source, for a predetermined time period; filtering the light treated air using a high efficiency filter, having a rating of greater than or equal to MERV 11; delivering treated air to a volume via an air outlet.

In some embodiments, the present specification discloses an air management system for reducing or preventing exposure to and inhalation of aerosol or droplet pathogens to individuals in a room, comprising: a housing; an air inlet or vent formed within the housing; a dust filter, positioned behind the air inlet, wherein said filter is a low efficiency filter; at least one fan, positioned within the housing, wherein said fan operates at an air flow rate ranging from 100 to 5000 cubic feet per minute; at least one UV light source positioned within the housing; a high-efficiency filter positioned within the housing; an air outlet of vent formed within the housing.

Optionally, the system is capable of purifying, sterilizing, sanitizing, treating, or disinfecting air in a room having a volume ranging from 100 to 50,000 cubic feet.

Optionally, air that is received, via the air inlet and through the dust filter is routed to the UV light source using the at least one fan.

Optionally, the air is exposed to UV light for at least one millisecond, and preferably for a suitable time period to effectuate pathogen inactivation.

Optionally, the UV light source provides light at a wavelength ranging from 100 nm to 400 nm.

Optionally, the UV light source comprises a germicidal UV-C light.

Optionally, the at least one fan is positioned to create turbulence and increase a rate of air flow.

Optionally, the air management system further comprises at least one ionizer.

Optionally, the air management system further comprises at least one photocatalytic filter.

Optionally, the at least one fan is a backward curved centrifugal fan.

Optionally, the air management system can be deployed in several configurations, including wall-mountable, floor-mountable, table-top, stand-alone or counter-mountable.

Optionally, the air management system is configured to purify, sterilize, sanitize, treat, or disinfect at an air flow rate ranging from 100 to 3000 cubic feet per minute (CFM).

Optionally, an air exchange rate ranges from 5 to 20 air exchanges per hour, which is calculated as 60 times the CFM of the system divided by the total volume of the room.

Optionally, the housing of the air management system has dimensions ranging from 6 inches to 60 inches.

Optionally, the air management system weighs less than 100 lbs.

Optionally, a unit dwell time for air is less than 1 second.

Optionally, a UV dose for air is less than 0.05 W/cm².

Optionally, the air management system generates non-laminar airflow.

Optionally, the inlet filter operates with a Minimum Efficiency Reporting Value (MERV) of less than or equal to 11 and the outlet filter a operates with Minimum Efficiency Reporting Value (MERV) of greater than or equal to 11 at the outlet.

The aforementioned and other embodiments of the present specification shall be described in greater depth in the drawings and detailed description provided below.

### BRIEF DESCRIPTION OF THE DRAWINGS

These and other features and advantages of the present invention will be further appreciated, as they become better understood by reference to the detailed description when considered in connection with the accompanying drawings:

FIG. 1 shows two graphs depicting mouth breathing air flow parameters for particle transmission;

FIG. 2 shows two graphs depicting nasal breathing air flow parameters for particle transmission;

FIG. 3 shows two graphs depicting sneezing air flow parameters for particle transmission;

FIG. 4 shows two graphs depicting coughing air flow parameters for particle transmission;

FIG. 5A is a front elevation view illustration of an outer surface or housing of a room air management system, in an embodiment of the present specification;

FIG. 5B is a right side elevation view illustration of a first side of an outer surface or housing of a room air management system, in an embodiment of the present specification and as shown in FIG. 5A;

FIG. 5C is a left side elevation view illustration of a second side of an outer surface or housing of a room air management system, in an embodiment of the present specification and as shown in FIG. 5A;

FIG. 5D is a top plan view illustration of a top side of an outer surface or housing of a room air management system, in an embodiment of the present specification and as shown in FIG. 5A;

FIG. 5E is a bottom plan view illustration of a bottom side of an outer surface or housing of a room air management system, in an embodiment of the present specification and as shown in FIG. 5A;

FIG. 5F is a perspective view of the room air management system shown in FIG. 5A, in an embodiment of the present specification;

FIG. 6A is an illustration showing a directionality of convection current air flow;

FIG. 6B is another illustration showing a directionality of convection current air flow;

FIG. 7 is an exploded view of an outer surface or housing of a room air management system, in an embodiment of the present specification and shown in FIGS. 5A-5F;

FIG. 8A is an exploded view of a front interior portion of a room air management system, in an embodiment of the present specification;

FIG. 8B is an exploded side elevation view of a room air management system, in an embodiment of the present specification;

FIG. 8C is a table showing performance characteristics and dimensional data for various 2-inch deep pleated filters that may be employed with some embodiments of the present specification;

FIG. 9A is a front elevation view of a back interior portion of a room air management system, in an embodiment of the present specification, showing internal components;

FIG. 9B is a perspective view of a back interior portion of a room air management system, in an embodiment of the present specification, showing internal components;

FIG. 9C is an exploded view of a first shroud assembly and a second shroud assembly for housing a fan or blower in accordance with some embodiments of the present specification;

FIG. 9D shows various illustrations of a backward curved centrifugal fan that may be employed in some embodiments of the present specification;

FIG. 9E shows a table and corresponding graph describing operational parameters and performance characteristics of a backward curved centrifugal fan that may be employed in some embodiments of the present specification;

FIG. 9F shows a table and corresponding graph describing operational parameters and performance characteristics of a backward curved centrifugal fan that may be employed in some embodiments of the present specification;

FIG. 9G shows a table and corresponding graph describing operational parameters and performance characteristics of a backward curved centrifugal fan that may be employed in some embodiments of the present specification;

FIG. 9H shows a table and corresponding graph describing operational parameters and performance characteristics of a backward curved centrifugal fan that may be employed in some embodiments of the present specification;

FIG. 9I shows a table and corresponding graph describing operational parameters and performance characteristics of a backward curved centrifugal fan that may be employed in some embodiments of the present specification;

FIG. 9J is a perspective view of a control panel used for operating the room air management system in accordance with some embodiments of the present specification;

FIG. 10A is an illustration of a room air management system showing a non-linear pattern of internal air flow, in accordance with some embodiments of the present specification;

FIG. 10B is an illustration of a room air management system showing another non-linear pattern of internal air flow, in accordance with some embodiments of the present specification;

FIG. 10C is an illustration of the room air management system showing yet another non-linear pattern of internal air flow, in some embodiments of the present specification;

FIG. 11A is a front elevation view of a room air management system, as described in some embodiments of the present specification, showing a cross-section A-A, which is expanded in FIG. 11B;

FIG. 11B is an internal, cross-section view of the room air management system of the present specification, as shown in FIG. 11A;

FIG. 12A is a schematic block flow diagram illustrating an operational flow of air through a room air management system in accordance with some embodiments of the present specification;

FIG. 12B is another schematic block flow diagram illustrating an operational flow of air through a room air management system in accordance with some embodiments of the present specification;

FIG. 12C is yet another schematic block flow diagram illustrating an operational flow of air through a room air management system in accordance with some embodiments of the present specification;

FIG. 12D is a flow diagram showing steps of a method for changing a filter in accordance with some embodiments of the present specification;

FIG. 13A is a block flow diagram illustrating the operational flow of a room air management system employing UV filtration and used as a stand-alone unit, in some embodiments of the present specification;

FIG. 13B is a schematic diagram of a non-linear hollow tube pathway, in accordance with some embodiments of the present specification;

FIG. 14 illustrates a plurality of UV light sources positioned outside the non-linear hollow tube pathway of FIG. 13B, in accordance with some embodiments of the present specification;

FIG. 15 illustrates a plurality of UV light sources positioned within the non-linear hollow tube pathway of FIG. 13B, in accordance with some embodiments of the present specification;

FIG. 16 is a schematic diagram of a non-linear hollow tube pathway incorporating a plurality of hollow quartz balls, in accordance with some embodiments of the present specification;

FIG. 17 is a schematic diagram of a hollow quartz ball shown in FIG. 16, in accordance with some embodiments of the present specification;

FIG. 18 illustrates a plurality of UV light sources positioned outside the non-linear hollow tube pathway of FIG. 16, in accordance with some embodiments of the present specification;

FIG. 19 illustrates a plurality of UV light sources positioned within the non-linear hollow tube pathway of FIG. 16, in accordance with some embodiments of the present specification;

FIG. 20A is a schematic diagram of a plurality of components of a room air management system, in accordance with a first embodiment of the present specification;

FIG. 20B shows a perspective view of a plurality of components of a room air management system, in accordance with a first embodiment of the present specification;

FIG. 21A is a schematic diagram of a plurality of components of a room air management system, in accordance with a second embodiment of the present specification;

FIG. 21B shows a perspective view of a plurality of components of a room air management system, in accordance with a second embodiment of the present specification;

FIG. 22A is a schematic diagram of a plurality of components of a room air management system, in accordance with an embodiment of the present specification;

FIG. 22B is a perspective side view of a plurality of components of a room air management system, in accordance with an embodiment of the present specification;

FIG. 22C is another perspective side view of a plurality of components of a room air management system, in accordance with an embodiment of the present specification;

FIG. 23 shows a plurality of views of a hollow quartz tube that may be used to fabricate non-linear pathways for air flow, in accordance with some embodiments of the present specification;

FIG. 24 shows a plurality of views of a hollow quartz ball or sphere, in accordance with some embodiments of the present specification;

FIG. 25 shows a plurality of views of a beaded hollow quartz tube that may be used to fabricate non-linear pathways for air flow, in accordance with some embodiments of the present specification;

FIG. 26 shows a plurality of views of a spiral hollow quartz tube that may be used to fabricate non-linear pathways for air flow, in accordance with some embodiments of the present specification;

FIG. 27A shows a perspective view of a plurality of components of a room air management system, in accordance with some embodiments of the present specification;

FIG. 27B shows a perspective view of a plurality of components of a room air management system, in accordance with some embodiments of the present specification;

FIG. 27C shows a perspective view of a plurality of components of a room air management system, in accordance with some embodiments of the present specification;

FIG. 28A shows a first perspective view of a plurality of components of a room air management system, in accordance with some embodiments of the present specification;

FIG. 28B shows a second perspective view of a plurality of components of a room air management system, in accordance with some embodiments of the present specification; and

FIG. 28C shows a third perspective view of a plurality of components of a room air management system, in accordance with some embodiments of the present specification.

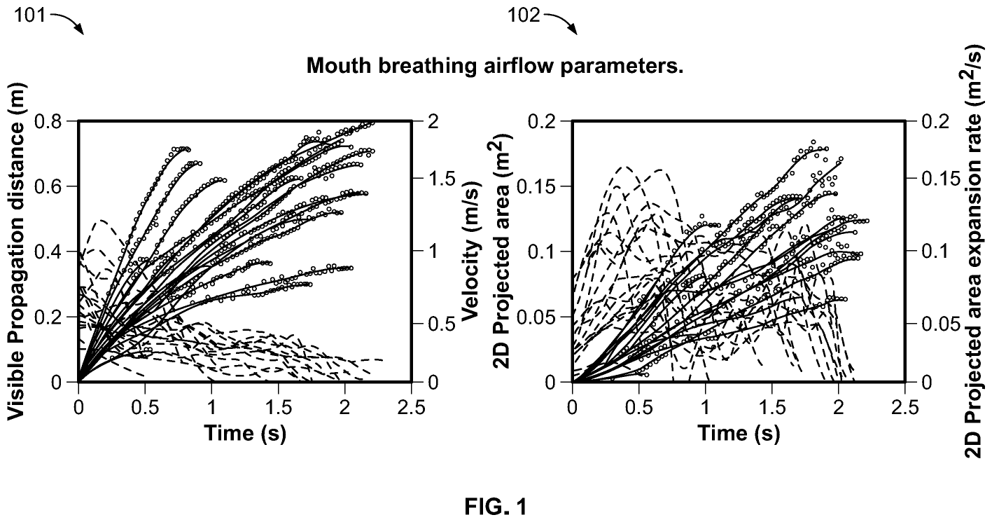

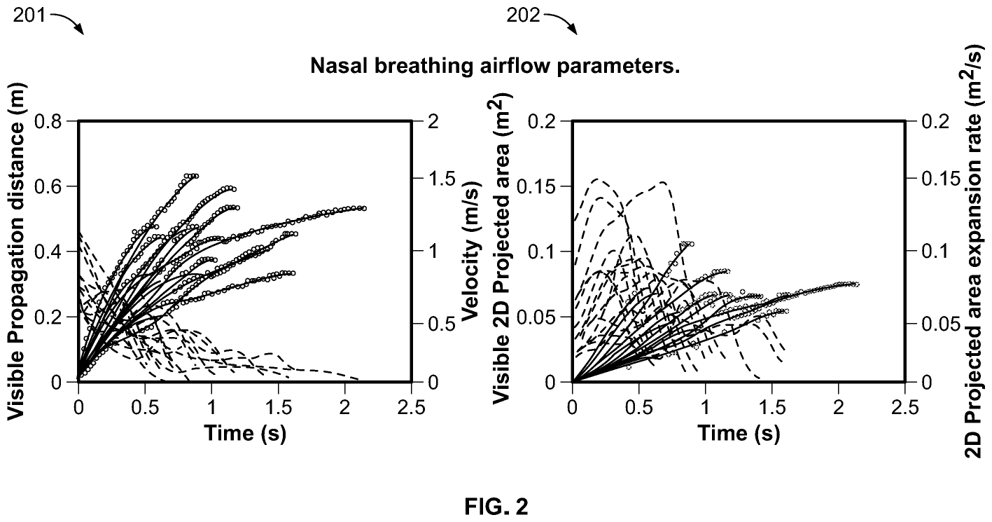

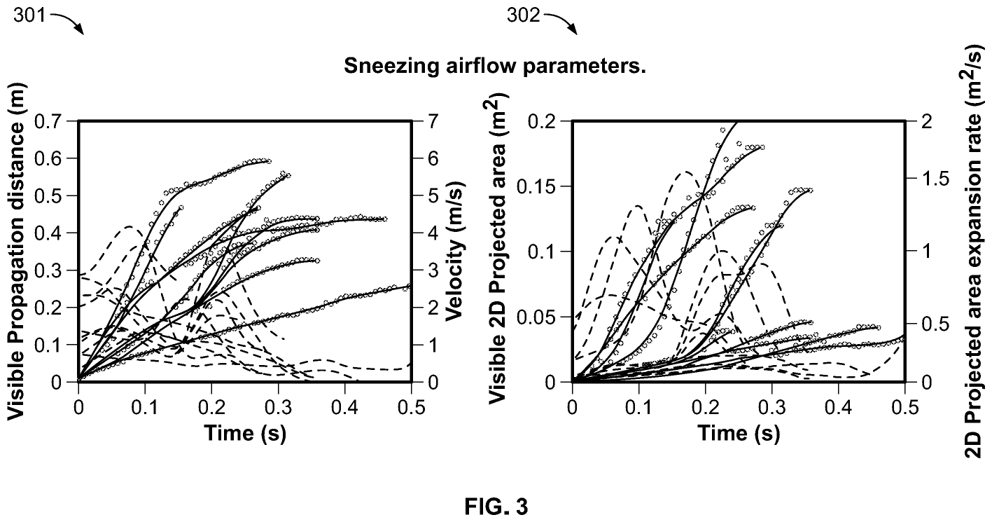

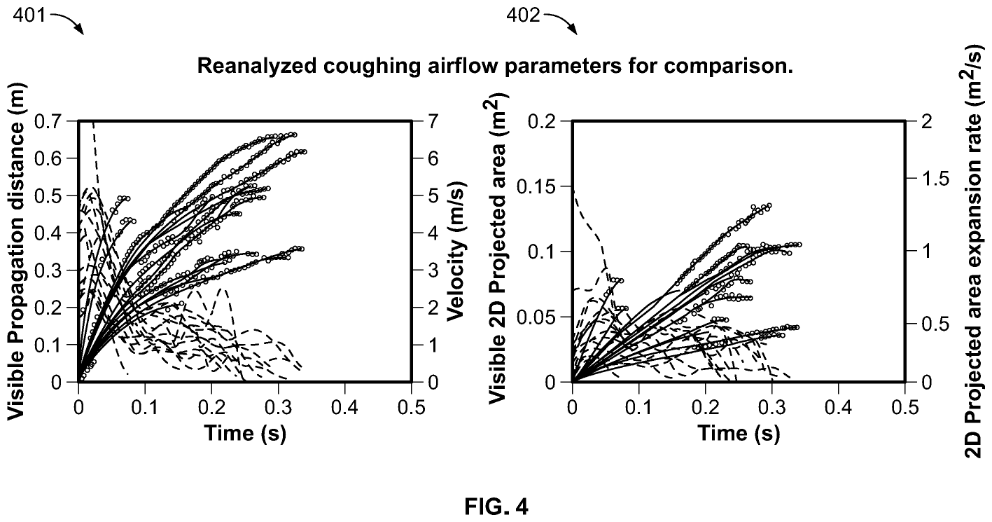

### DETAILED DESCRIPTION

The present specification is directed toward various systems and methods for room air management. In embodiments, the methods and systems of the present specification are designed to provide reliable air filtration, purification, disinfection and/or sterilization of air to effectively and reliably remove or eliminate transmittable, such as aerosol and droplet pathogens, including volatile organic compounds (VOCs), pollutants, formaldehyde, particulate matter, viruses, bacteria, mold, spores and other infectious particles. In particular, the present specification is directed towards a room air management system that effectively employs filtration, purification, disinfection and/or sterilization techniques using physical filtration, UV sterilization, ionization and/or photocatalytic oxidation (PCO) or photo electrochemical oxidation (PECO).

In embodiments, the system also synergistically combines the effects of photo electrochemical oxidation (PECO) or photochemical oxidation (PCO) with ionization (unipolar, negative-ion, bipolar or cold plasma) to treat (i.e. disinfect and/or sterilize) both the air inside and outside of the air management system. The system of the present specification may also employ an activated charcoal or carbon filter to remove harmful ions, ozone, or volatile organic compounds (VOCs). Additionally, the filter may include humidification, heating, or cooling mechanisms to impact the size of the particles in the air (such as droplets or aerosol) thus impacting the filtration, disinfection, sterilization or destructive ability of the air management system. The filter may also, employ antimicrobial coatings to enhance germicidal efficacy. In embodiments, particle size may be impacted by humidification, which increases particle size; by heating, which may decrease particle size; and/or by cooling, which may slow down the decrease in particle size. The particle size may also be affected by ionization, which typically results in an increase in particle size. The embodiments of the present specification advantageously exploit the inherent properties of particles within the air in order to treat the air to disinfect and/or sterilize the air.

In embodiments, the systems described in the present specification may be of varying sizes and may accommodate a range of airflow rates and as such, are capable of operating in a wide range of room sizes and/or indoor air purification/sanitization requirements to deliver an appropriate clean air delivery rate (CADR). EPA recommends the following CADR for a given room area, as shown in Table 1 (noting that the chart provided is for estimation only and that the CADRs are based on an 8-foot ceiling).

TABLE 1
Portable Air Cleaner Sizing for Particle Removal

| | | | | | | |
|---|---|---|---|---|---|---|
| Room area | 100 | 200 | 300 | 400 | 500 | 600 |
| (square | | | | | | |
| feet) | | | | | | |
| Minimum | 65 | 130 | 195 | 260 | 325 | 390 |
| CADR | | | | | | |
| (cfm) | | | | | | |

In embodiments, the systems of the present specification may be a stand-alone unit. In other embodiments, the system of the present specification may be modified to work in conjunction with a central heating, ventilation, and air conditioning (HVAC) unit. In embodiments, the systems of the present specification may be a wall-mountable unit. In other embodiments, the systems of the present specification may be a floor mountable unit or a counter mountable unit or on a mobile cart. In still other embodiments, the systems of the present specification may be table-top systems. In embodiments, the systems of the present specification are designed to expose air to a UV-C source enabling the killing of transmittable infectious pathogens, in aerosolized, droplet, and other forms. The system of the present specification is designed such that it is consumer/user-friendly and easy to operate.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

In various embodiments, the system includes at least one processor capable of processing programmatic instructions, has a memory capable of storing programmatic instructions, and employs software comprised of a plurality of programmatic instructions for performing the processes described herein.

It should be noted herein that the terms user, patient, and person may be used interchangeably and may be used to refer to an individual using the devices of the present specification.

In embodiments of the present specification, the term “airborne” is used to describe any size particle (droplet, dust, pollen) capable of travel through the air. For respiratory droplets, this may include droplets that are close to the source and those that have moved farther away.

In terms of infectious disease, “airborne” transmission conventionally is used to refer to infections capable of being transmitted through exposure to infectious, pathogen-containing, small droplets and particles (aerosol) suspended in the air over long distances and that persist in the air for long times.

In terms of infectious disease “droplet” transmission refers to infection spread through exposure to virus-containing respiratory droplets (i.e. larger and smaller droplets and particles) exhaled by an infectious person. Transmission is more likely to occur when someone is in close proximity to the infectious person, and typically, within about six feet.

In terms of infection disease “contact” or “fomite” transmission refers to infection spread through direct contact with an infectious person, either via touching that person or an article or surface that has become contaminated.

The embodiments of the present specification may apply to “airborne transmission”, “droplet transmission” and “contact transmission”, and the use of one term is meant to be exemplary and not to be construed as limiting to such embodiment.

In embodiments, the term “transmittable particles” is used to refer to all forms of particles, including, but not limited to aerosol and droplet forms, organisms in aerosol form, and single organism “naked” bacteria, viruses, molds, and/or spores not encapsulated in a droplet.

In embodiments, the term “log kill” is used to refer to the percentage of reduction or log reduction in concentration of an airborne pathogen. The term refers to a logarithmic scale that indicates the percentage of pathogen kills. Thus, the term “log reduction” or “log kill” indicates a 10-fold reduction, which means that with every step, the number of pathogens present is reduced by 90 percent (i.e. 1 log=90%, 2 log=99%, 3 log=99.9%, and so forth). For example, if there are one million a 1-log reduction would reduce the number of bacteria by 90 percent, or 100,000 bacteria remaining. A 2-log reduction removes 99 percent, leaving behind 10,000 bacteria, 3-log removes 99.9 percent to leave behind 1,000 bacteria, and so on through a 6-log kill, which leaves behind only one cell in one million. A 6-log kill is considered sterile.

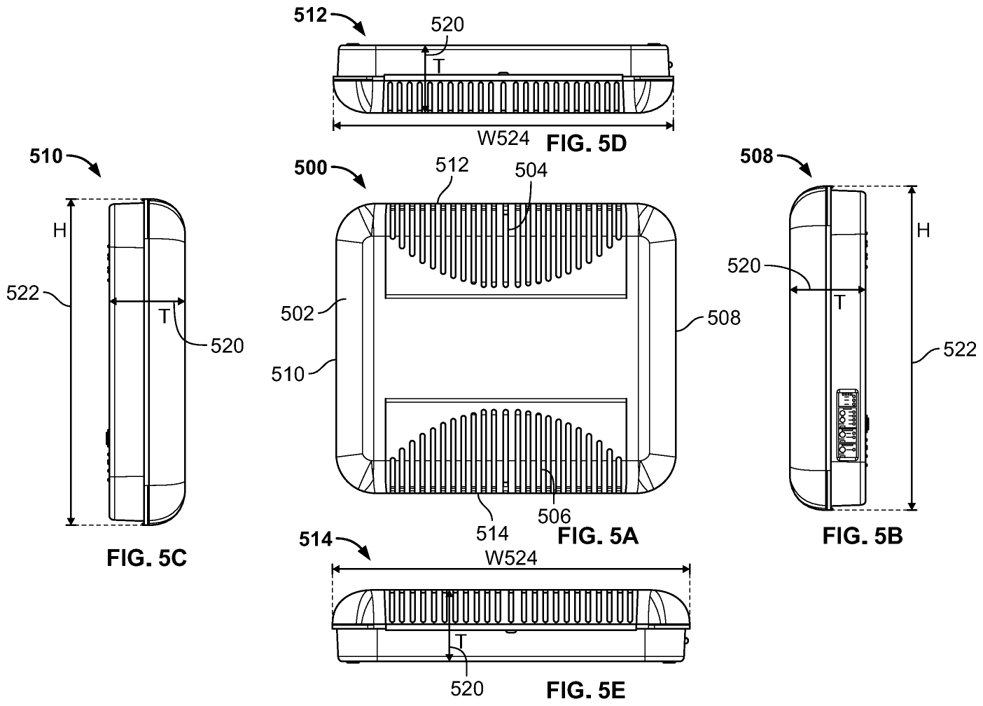

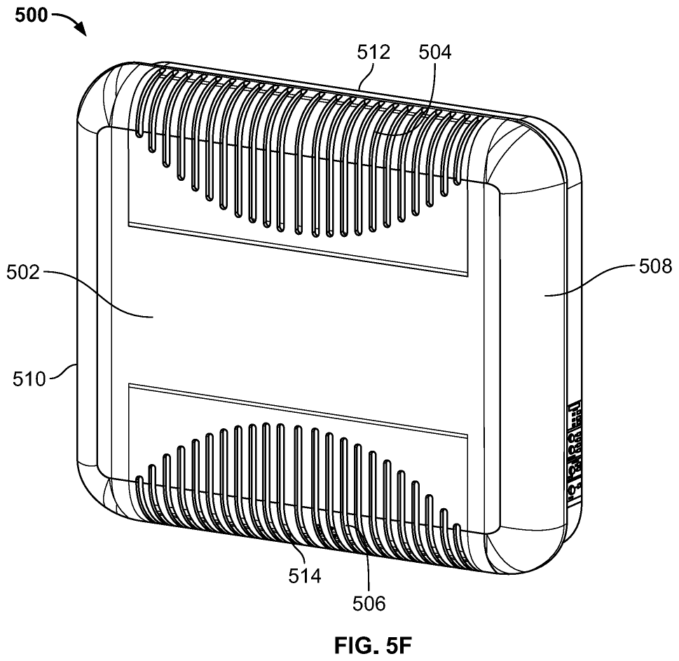

FIG. 5A is an illustration of a housing and/or outer surface of a room air management system, which may be a wall-mountable, table-mountable, or floor-mountable unit, in some embodiments of the present specification. As shown in FIG. 5A, unit 500 may include an outer cover or housing 502, an upper vent or air outlet 504, and a lower vent or air inlet 506. FIG. 5B is a right side elevation view illustration of a first side 508 of an outer surface or housing of a room air management system, in an embodiment of the present specification and as shown in FIG. 5A. FIG. 5C is a left side elevation view illustration of a second side of an outer surface or housing of a room air management system, in an embodiment of the present specification and as shown in FIG. 5A. FIG. 5D is a top plan view illustration of a top side 512 of an outer surface or housing of a room air management system, in an embodiment of the present specification and as shown in FIG. 5A. FIG. 5E is a bottom plan view illustration of a bottom side 514 of an outer surface or housing of a room air management system, in an embodiment of the present specification and as shown in FIG. 5A. FIG. 5F is a perspective view of the outer surface of the room air management system 500 described with respect to FIG. 5A.

Referring simultaneously to FIGS. 5A to 5D, in embodiments, the housing of the room air management system is adapted to be hung on a wall at a height from a floor at a base of the wall to a bottom side 514 of the housing 502 and wherein the height is in a range of 1.5 feet to 4.5 feet. In an embodiment, the housing 502 of the room air management system is adapted to be hung on a wall at a height of 3 feet from a floor at a base of the wall to the bottom side 514 of the housing 502.

In embodiments, the housing of the system of the present specification has a total thickness (T) 520 defined by a distance between a first exterior surface positioned against the wall and a second exterior surface of the housing running parallel to the wall, wherein distance is in a range of 4 inches to 12 inches, and preferably, 5 inches to 7 inches. In an embodiment, the thickness of the room air management system is 5.6 inches.

In embodiments, the housing 502 of the system of the present specification has an overall height (H) 522 ranging from 18 inches to 60 inches, preferably ranging from 35 inches to 45 inches and a width (W) 524 in a range of 18 inches to 60 inches, preferably in a range of 35 inches to 45 inches.

In embodiments, the room air management system of the present specification is capable of purifying, sanitizing or treating air at a rate ranging from 100 cubic feet/minute (CFM) to 3000 CFM. In an embodiment, the room air management system of the present specification is capable of purifying air at a rate of 300 CFM for a room size/volume of 2000 cubic feet (CF). In an embodiment, the room air management system of the present specification is capable of purifying air at a rate of 600 CFM for a volume of 4000 CF. In an embodiment, the room air management system of the present specification is capable of purifying air at a rate of 1200 CFM for a volume of 6000 CF. In embodiments, the preferred target air exchange rate (AER) is at least 5 air exchanges/hour (referred to as “5 ACH”). Air exchange rates, or “air changes per hour,” simply refer to the number of times that air gets replaced in each room every hour. The American Society of Heating, Refrigerating and Air-Conditioning Engineers (ASHRAE) provides guidelines for air changes per hour, and they vary depending upon the room. For example, bedrooms should have 5-6 air exchanges/hour, kitchens 7-8 air exchanges/hour, and laundry rooms should have 8-9 air exchanges/hour. Outdoor air ventilation in spaces where there may be congregations of people should have at least 3 air exchanges/hour. Table 2A shows a range of baseline air exchange rates. Table 2B shows a comparison between typical baseline ventilation and good baseline ventilation in correlation with air management unit size.

TABLE 2A
Target Air Exchange Rates

| | |
|---|---|
| Ideal | 6 ACH |
| Excellent | 5-6 ACH |
| Good | 4-5 ACH |
| Absolute Minimum | 3-4 ACH |

TABLE 2B
Baseline Ventilation and Occupancy Compared to Unit Size

| | | High | Low |
|---|---|---|---|
| Baseline Ventilation | Unit Size | Occupancy (SF) | Occupancy (SF) |
| Typical (1.5 AER) | 1200 CFM | 2000 | 2600 |
| Typical (1.5 AER) | 600 CFM | 1000 | 1300 |
| Typical (1.5 AER) | 300 CFM | 500 | 650 |
| Good (3 AER) | 1200 CFM | 3000 | 4500 |
| Good (3 AER) | 600 CFM | 1500 | 2200 |
| Good (3 AER) | 300 CFM | 750 | 1100 |

To calculate the recommended number of air changes per hour (ACH), the following equation is employed:

ACH=60 Q/Vol Equation 1

where Q is the CFM of the device and Vol is the total cubic feet of the room.

In embodiments, the room air management system of the present specification is designed to and capable of providing a convection current in a room to “direct” infectious particles towards the ground or floor. It should be noted that most infectious particles are produced at four to six feet, a person's nose or mouth height, above the ground level, and with time, “drop” or settle to the ground. Thus, particles, such as aerosols may be lost to surfaces via settling, diffusion, impaction, and/or electrostatic deposition. In addition, some aerosolized particles can travel beyond four to six feet and can remain in the air for hours without air circulation owing to their low mass because even slight air flows have a greater impact than gravity alone on particle position and transmission. The droplet spread can be altered by changes in the air flow in a room or enclosed space, such as can be caused by a fan or an HVAC unit. Further, if the air containing aerosols or respiratory droplets is not purified, there is the risk of “re-suspension”, where “dropped” particles are recirculated back into the air. A pattern of air movement, such as a convection current flow, will assist in a more effective air exchange, and coupled with various air purification techniques, enable the room air management system to kill or remove harmful/infectious pathogens/chemicals that are spread by air, aerosol and respiratory droplets. In addition, the methods and systems of the present specification will circulate air in such a manner to sufficiently remove transmittable particles from surfaces by air replacement. Thus, fomite is indirectly treated by reducing airborne contamination of surfaces and is directly treated by ionization, whereby ions settle onto the fomite killing the pathogens via electroporation or cell membrane damage.

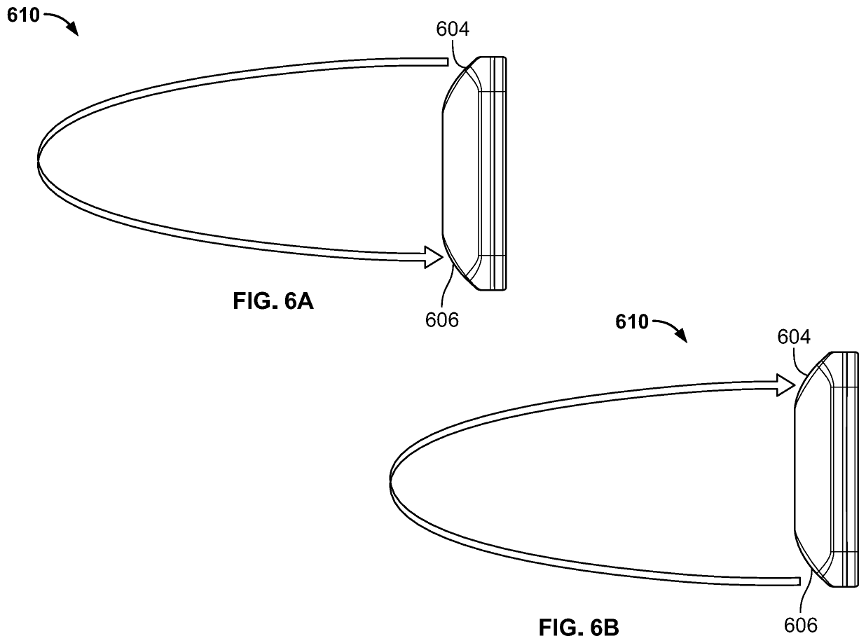

FIG. 6A is an illustration showing a convection current air flow that may be achieved by the room air management system of the present specification. As shown in FIG. 6A, the flow of air 610 is directed from an upper vent 604 which outputs air down through to a lower vent 606 which intakes the air that is redirected from upper vent 604. FIG. 6B is an illustration showing a convection current air flow that may be achieved by the room air management system of the present specification. As shown in FIG. 6B, the flow of air 610 is directed from a lower vent 606 which outputs air down through to an upper vent 604 which intakes the air that is redirected from lower vent 606. The embodiments of the present specification are capable of purifying air every three (3) to twelve (12) minutes, not accounting for room diffusion or leakage, thus providing 3-20 air exchanges/hour, where room diffusion or leakage refers to contamination that enters the room continuously. In addition, it should be noted that it will take more time to clean the air in a room full of infected persons (such as with COVID-19) than a chamber with a static baseline level of contamination. In some embodiments, the systems of the present specification draw air generally from the lower two-third of the room and direct it toward the upper two-thirds of a room. The various convection current options can be chosen based on the specific room requirement and depending on the internal room airflow created by room fans or HVAC units.

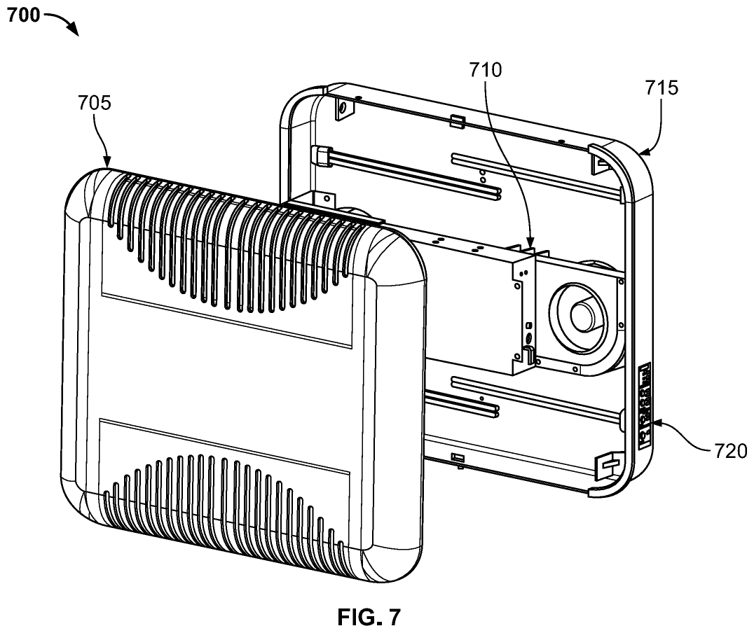

FIG. 7 is an exploded view of an outer surface or housing of a room air management system, in an embodiment of the present specification and shown in FIGS. 5A-5F. Room air management system 700 includes a front shell assembly 705, and electrical box assembly 710, a back assembly 715, and a side panel assembly 720.

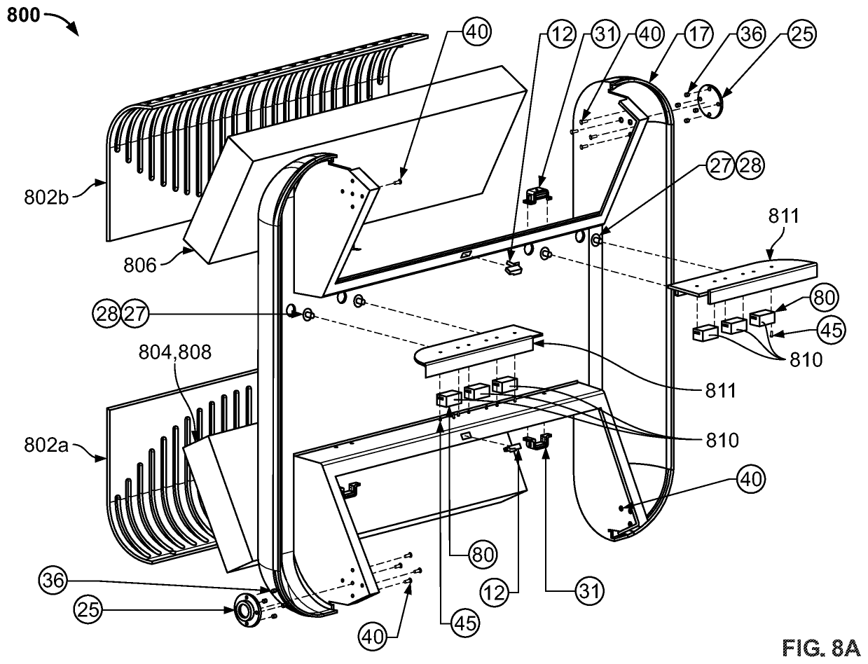

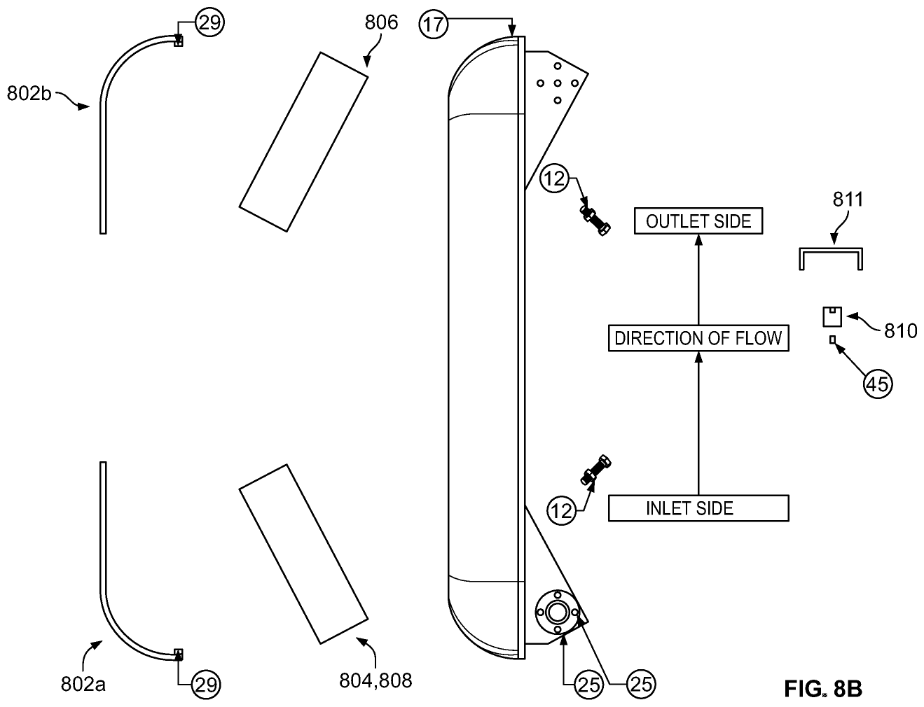

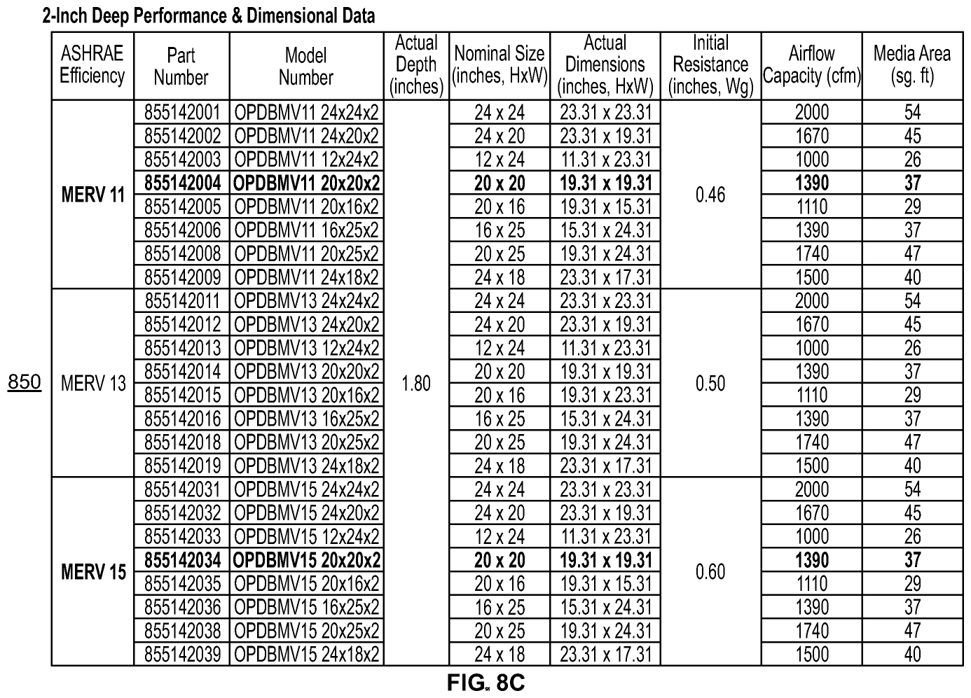

FIG. 8A is an exploded view of a front shell assembly of the outer surface or housing of a room air management system, in an embodiment of the present specification. As shown in FIG. 8, front shell assembly 800 includes a first plastic wing 802a, located at the bottom portion of the assembly, which further includes air vent openings, thus forming a lower vent or air intake and a second plastic wing 802b, located at the top portion of the front shell assembly, which further includes air vent openings, thus forming an upper vent (as shown in FIG. 5A). Various filters are used in several embodiments throughout the present specification. The United States Environmental Protection Agency sets forth standards for Minimum Efficiency Reporting Values (MERVs) to report a filter's ability to capture larger particles between 0.3 and 10 microns (μm), where the rating is derived from a test method developed by ASHRAE. Table 3 is a table describing various MERV ratings and average particle size efficiency.

TABLE 3

| | Average Particle Size in Microns |
|---|---|
| MERV Rating | (Efficiency Percentage) |
| 1-4 | 3.0-10.0 (less than 20%) |
| 6 | 3.0-10.0 (49.9%) |
| 8 | 3.0-10.0 (84.9%) |
| 10 | 1.0-3.0 (50%-64.9%) |
| | 3.0-10.0 (85% or greater) |
| 12 | 1.0-3.0 (80%-89.9%) |
| | 3.0-10.0 (90% or greater) |
| 14 | 0.3-1.0 (75%-84%) |
| | 1.0-3.0 (90% or greater) |
| 16 | 0.3-1.0 (75% or greater) |

It should be noted that a low efficiency filter, as used in this specification, refers to a filter that holds a MERV rating of less than or equal to 11. It should be noted that a high efficiency filter, as used in this specification, refers to a filter that holds a MERV rating of greater than or equal to 11, and typically includes HEPA and ULPA filters.

An inlet filter 804 is positioned behind a first plastic wing 802a for filtering the air that flows into the air management system of the present specification. In embodiments, inlet filter 804 is a particle filter or dust filter. In embodiments, filter 804 is a low-efficiency filter, which holds a rating of less than or equal to MERV 11. In embodiments, filter 804 is a MERV 7 or higher filter. In an embodiment, filter 804 is a MERV 8 filter that includes a carbon layer. In embodiments, filter 804 is employed to remove any dust or aerosol particles that may potentially carry a virus or other airborne pathogen. In embodiments, filter 804 is a pleated filter, wherein each pleat is of a certain dimension, for example, ranging from 1-4 inches. A pleated filter typically includes a large sheet that is pleated into a smaller “box”. The efficacy of the filter and/or the surface area of the filter is generally dependent on at least one of the type of filter paper, the flow of air that can be achieved across the filter, and the pressure of air flow across the filter. The filter employed may be of various dimensions. In an embodiment, the filter employed offers the largest surface area of filter paper pleated into the smallest volume of a pleated filter configuration. In an embodiment, filter 804 is on the order of 10 inches×30 inches and has a pleat thickness of 2 inches. FIG. 8C is a table 850 showing airflow performance characteristics, as determined by ASHRAE testing, and dimensional data for various 2-inch-deep pleated filters that may be employed with some embodiments of the present specification.

Referring back to FIG. 8A, the system includes optional ionizers 810, which are described in greater detail below. In embodiments, at least one ionizer 810 is placed in a housing or “wing wall” 811 and positioned upstream from filter 804. In embodiments, any pathogen(s) that is trapped in filter 804 are exposed to OH and superoxide (O₂⁻) radicals created by a photocatalytic oxidation (PCO) or photoelectrochemical oxidation (PECO) filter 808 to kill any residual pathogens. The PCO/PECO filter 808 also results in degradation of volatile organic compounds (VOCs) in the air. In embodiments, the photocatalytic filter may be fabricated from or coated with TiO₂ or any other PCO/PECO material as is known in the art. In embodiments, the PCO/PECO filter is formed in a honeycomb mesh pattern, similar to that of a window screen. In embodiments, the TiO₂ coating is activated by a UV light source, as described below, creating radicals and thus, killing any pathogen contained in air that flows through the PCO/PECO filter. In an embodiment, PCO/PECO filter 808 is on the order of 10 inches×30 inches and is 12 mm thick. The filter design is optimized to maximize the surface area of the filter in the smallest volume while maximizing the exposure to filter surface to the air flow and UV light.

An outlet filter 806 is positioned behind a second plastic wing 802b for filtering the air that flows out of the air management system of the present specification. In embodiments, filter 806 is a high efficiency filter. In embodiments, filter 806 is a filter with a MERV rating of ≥MERV 11. In embodiments, filter 806 is a filter with a MERV rating of ≤MERV 16. In embodiments, filter 806 is a filter with a MERV rating ranging between 11 and 16. In an embodiment, filter 806 is a MERV 15 filter that includes a carbon layer. In an embodiment, filter 806 is on the order of 10 inches×30 inches and has a pleat thickness of 2 inches. In embodiments, a back side of filter 806 may be exposed to and sanitized using a light source. In embodiments, the light source is a UV-C light source. It should be noted that there is a potential for any pathogen to be trapped in a filter owing to particle size. In a conventional system, the live pathogen may be released back into the air. By treating with a UV light source, pathogens remaining on the filter, which can become a reservoir for pathogens, are killed prior to air flowing out of the system. In some embodiments of the present specification, in operation, the destructive efficiency for killing MS2 Bacteriophage present on the outlet filter 806 is >99.9% at ≤30 minutes and >99.99% at ≤60 minutes.

In optional embodiments, an additional activated charcoal or carbon filter is employed and may be combined with filter 804 and/or filter 806. The first charcoal filter (coupled with filter 804) and the second charcoal filter (coupled with filter 806) are effective in reducing UV leak from the intake or the output vents of the room sanitization system, thus keeping UV-C exposure amongst occupants of the room below the threshold limit value (TLV). The American Conference of Governmental Industrial Hygienists (ACGIH) Committee on Physical Agents has established a threshold limit value (TLV) for UV-C exposure to avoid skin and eye injuries among those most susceptible. For a 254 nm UV light source, the TLV is 6 mJ/cm² over an eight-hour period. Optionally, the air is ionized by an ionizer prior (not shown) to being released into the room.

FIG. 8B is an exploded side elevation view of a room air management system, in an embodiment of the present specification. FIG. 8B shows first plastic wing 802a and second plastic wing 802b, inlet filter 804, outlet filter 806, PCO/PECO filter 808, and ionizer 810, which is positioned within wing wall or housing 811.

The room air management system of the present specification is, in some embodiments, split into chambers or sub-units. Thus, the inlet of the fan and associated components, such as pre-filters, are positioned in a first chamber. At least one fan and at least one associated UV light source are positioned within another chamber, which is further split into a second and third chamber. The outlet filters and associated components are positioned within a fourth chamber. Thus, as described in detail below, the one or more fans serve to separate the room air management system creating a top compartment or chamber (fourth chamber) positioned above the fans and a bottom compartment or chamber positioned below the fans (first chamber). The area housing the fans and UV light sources are in yet another chamber, which is bifurcated into two discrete chambers (second and third chambers). In embodiments, the UV light sources operate at the periphery between the chambers. The room air management system of the present specification advantageously uses the empty spaces within and between chambers to provide additional air purification and sterilization functionality.

In embodiments, the UV light source provides sterilization by at least one of a direct UV-C kill of the viral particles that traverse in and out of the aerosol floating in the air and/or by a “trap and kill” mechanism that exposes viral particles trapped in the filter to the UV-C light. The first mechanism, a direct kill mechanism, has a higher effectiveness for small aerosol particles and free virus particles (<1-2μ) which are harder to filter using mechanical filtration but require shorter dwell time for viral kill, owing to particle size. In comparison, the second mechanism, a “trap and kill” mechanism, is more effective at inactivating viral particles in the aerosol (>1-2μ) which are easier to trap in a mechanical filter, yet, because of the particle size requires a longer dwell time for viral inactivation. The dual UV-C based sterilization or disinfection mechanism is ideally suited when particles of different sizes are present within the infected aerosol.

In addition, the individual UV exposure time for each sub-systems of the dual UV-C based system will be different. Thus, the design of the air management system is optimized to deliver different UV-C doses/sec to airborne particles versus particles trapped in the filter. It should be noted that the dwell time for a trapped particle is much higher than that of floating particles, therefore, the dose/sec needed for a trapped particle is less than that for a floating particle to arrive at the total dose. Stated differently, a cumulative higher dose is needed for those particles that are trapped in the filter. In an embodiment, the dose/sec to particle(s) trapped in the filter is <50% of the UV-C dose/sec delivered to airborne particles. In one embodiment the dose/sec to particle(s) trapped in the filter ranges between 95% and 5% of the UV-C dose/sec to the airborne particles. In another embodiment, the dose/sec to the particle trapped in the filter ranges between 75% and 25% of the UV-C dose/sec to the airborne particles. The differential dose/sec allows for delivery of an effective cumulative dose to the infectious particle based on the particle location, particle size, and dwell time. In embodiment, a bioaerosol particle in the air is exposed to a first UV-C dose/sec (D1) for a first time duration/dwell time (T1) and a bioaerosol particle trapped on a filter is exposed to a second dose/second (D2) for a second time duration/dwell time (T2), wherein D1 is greater than D2 and T1 is less than T2. Thus, in an embodiment, the first cumulative total exposure (C1) for an airborne bioaerosol particle, wherein the first cumulative total exposure (C1) is defined as (C1)=(D1×T1) is less than a second cumulative total exposure (C2) for a filter-trapped bioaerosol particle, wherein the second cumulative total exposure is defined as (C2)=(D2×T2).

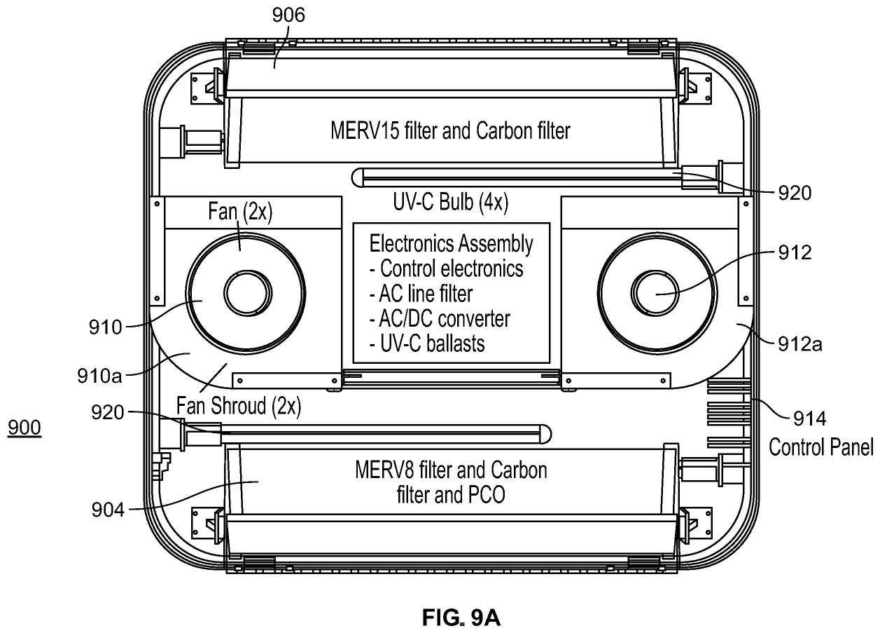

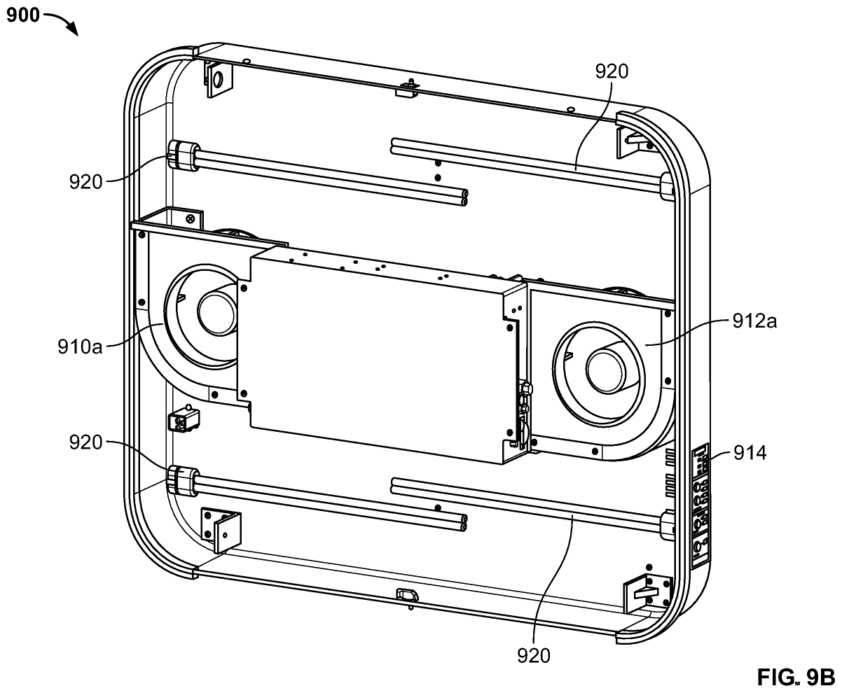

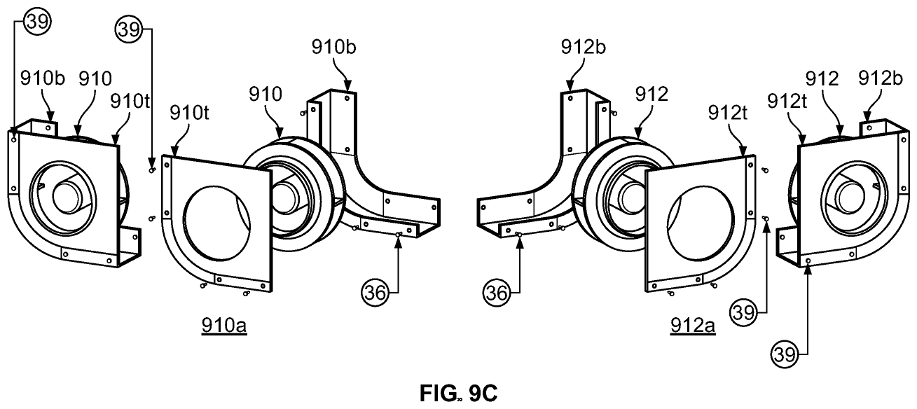

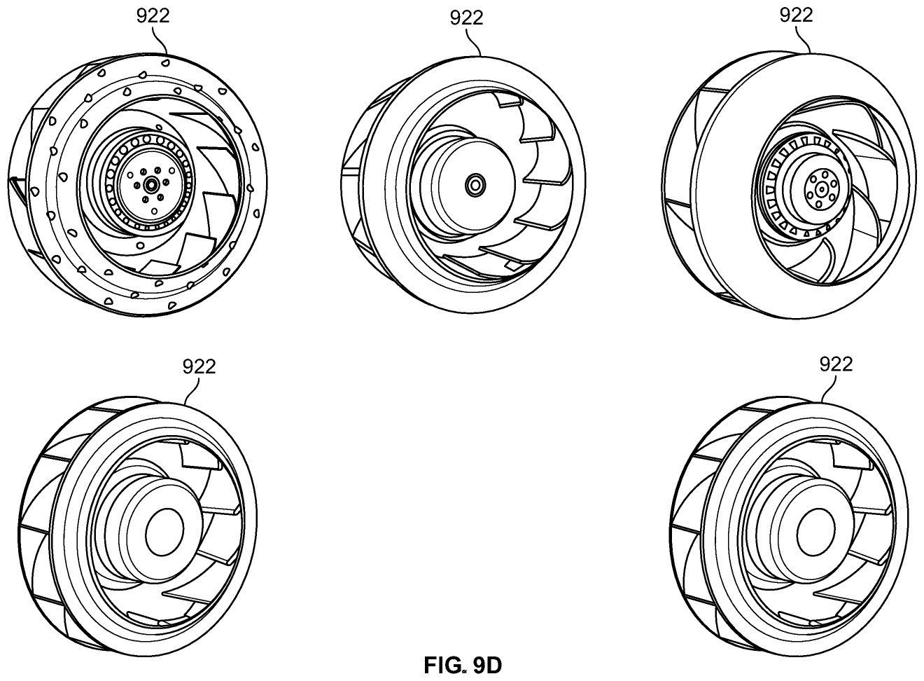

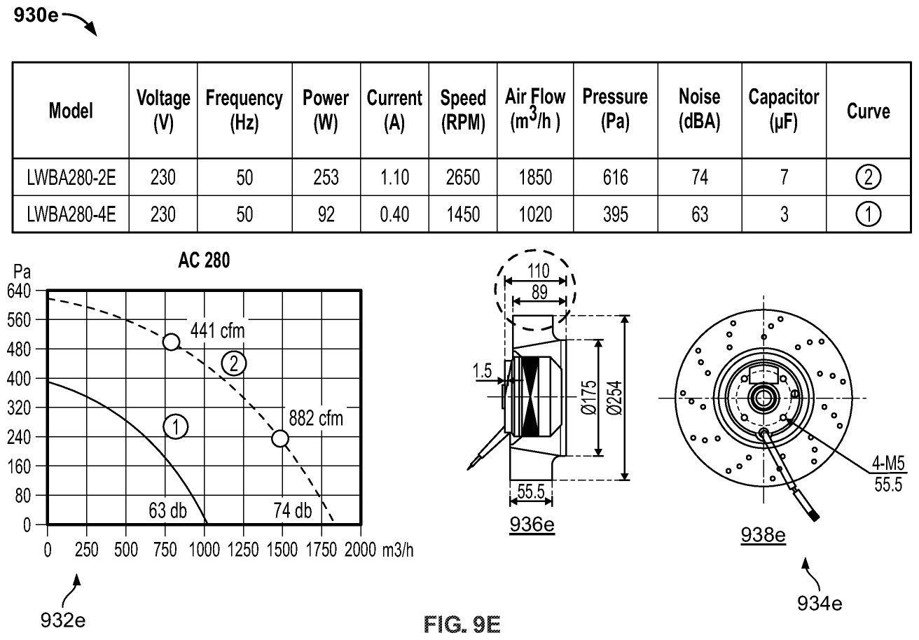

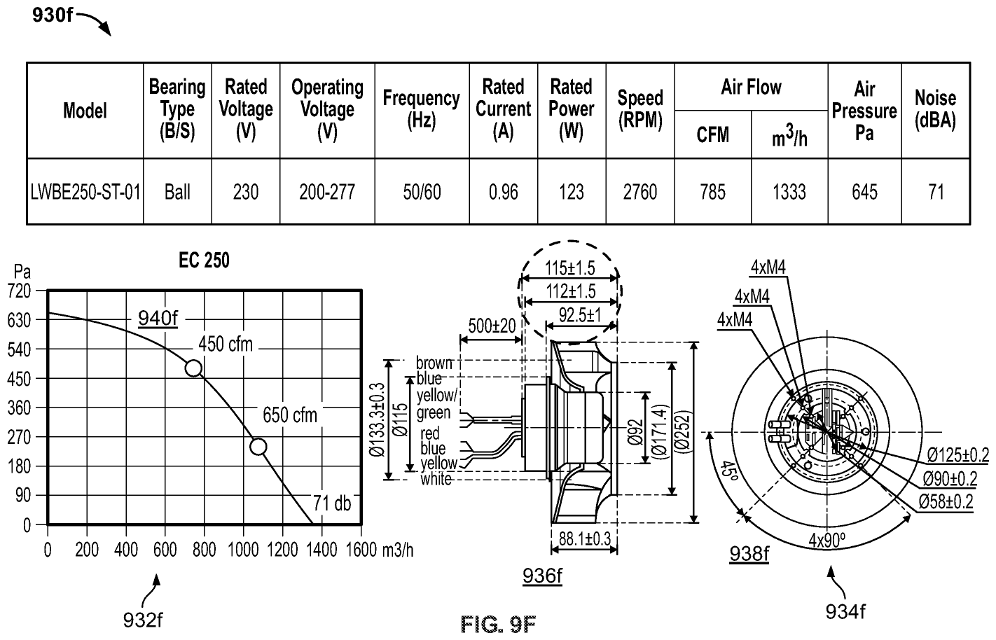

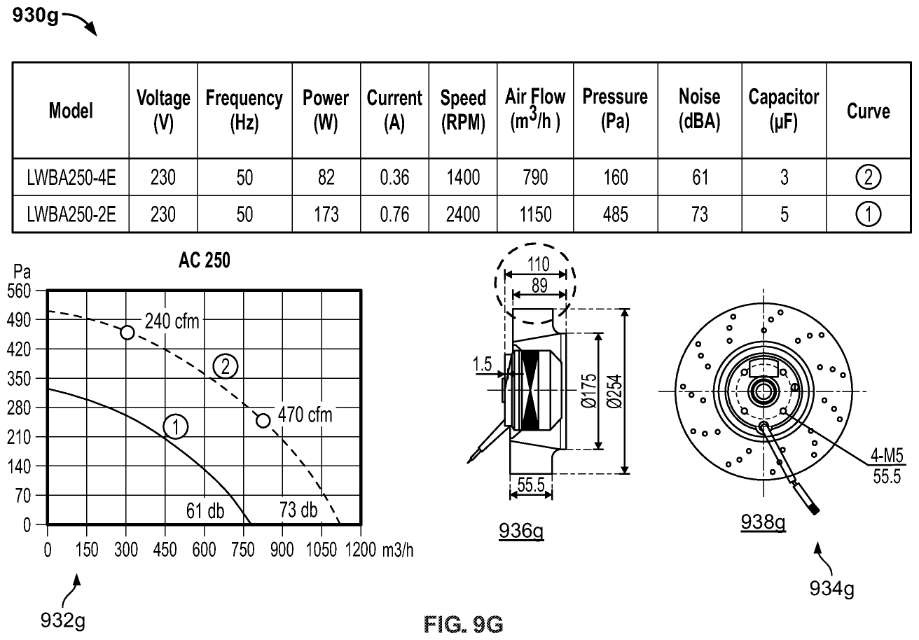

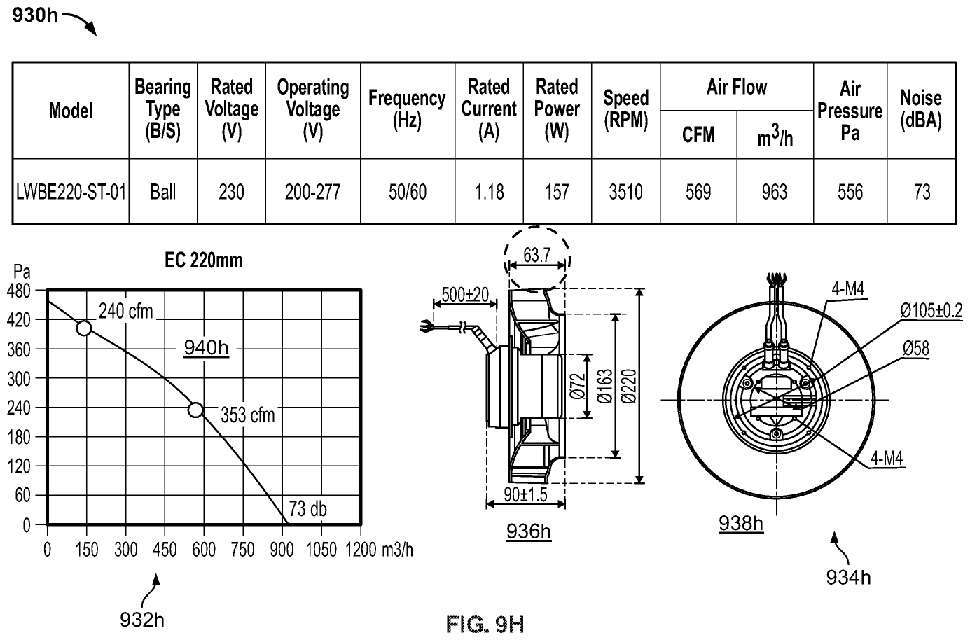

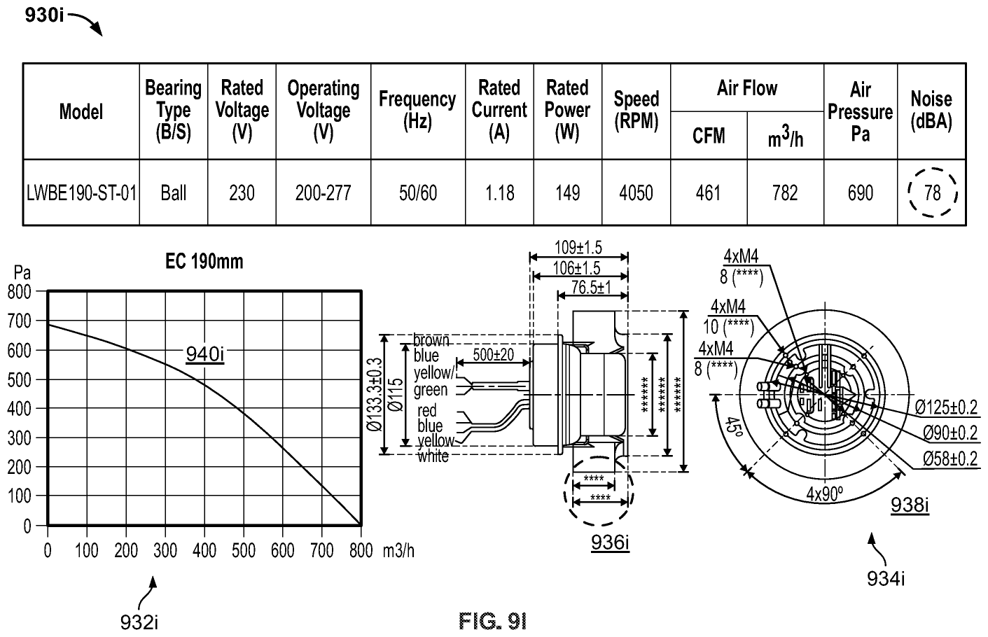

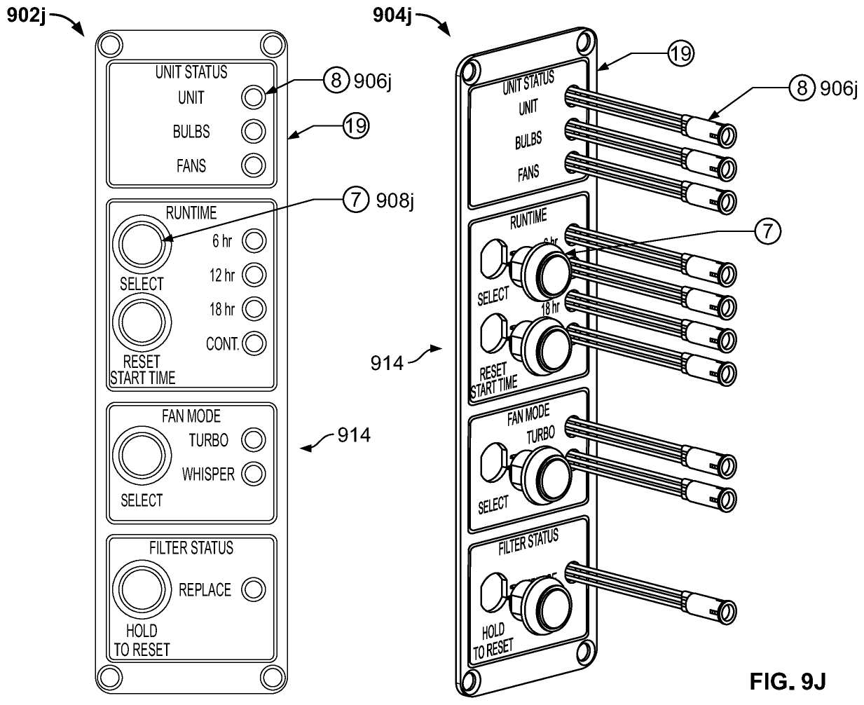

FIG. 9A is a front elevation view of a back interior portion of a room air management system, in an embodiment of the present specification, showing internal components. Room air management system 900 includes, as described with respect to FIG. 8, a first fan 910 and a second fan 912, each housed in a fan shroud, 910a and 912a, respectively. In an embodiment, the one or more fans (shown in FIGS. 9C and 9D) is a backward curved centrifugal fan. Referring to FIG. 9D, various examples of a backward curved centrifugal fan 922 that may be employed in embodiments of the present specification is shown, and may have a diameter ranging from 133 mm to 560 mm. FIGS. 9E, 9F, 9G, 9H, and 9I are various diagrams and tables showing performance characteristics and dimensions of backward curved centrifugal fans that may be employed in some embodiments of the present specification.

FIG. 9E shows a table 930e and corresponding graph 932e describing operational parameters and performance characteristics of a backward curved centrifugal fan 934e that may be employed in some embodiments of the present specification. The figure also illustrates line drawings of a side elevation 936e and a back side 938e of the fan 934e. Side elevation 936e shows a maximum thickness of the fan 934e, without its central shaft, to be approximately 110 centimeter (cm). In some embodiments, the impeller material of fan 934e is made from galvanized metal sheet. The fan 934e is provided with thermal protection overload (TOP) that is wired internally. Fan 934e operates within a temperature range of −10° C. to 60° C., and weighs approximately 3.9 Kg. Referring to the table 930e and the graph 932e, the two curves illustrate variation in air flow (measured in m³/h) with pressure (measured in Pa).

FIG. 9F shows a table 930f and corresponding graph 932f describing operational parameters and performance characteristics of a backward curved centrifugal fan 934f that may be employed in some embodiments of the present specification. The figure also illustrates line drawings of a side elevation 936f and a back side 938f of the fan 934f. Side elevation 936f shows a maximum thickness of the fan 934f, without its central shaft, to be in a range of 91.5 to 93.5 cm. Including the central shaft, thickness ranges from 113.5 to 116.5 cm. In some embodiments, the impeller material of fan 934f is made from a combination of plastic and reinforced glass fiber. Fan 934f operates within a temperature range of −10° C. to 60° C. Referring to the table 930f and the graph 932f, the curve 940f illustrates variation in air flow (measured in m³/h) with pressure (measured in Pa).

FIG. 9G shows a table 930g and corresponding graph 932g describing operational parameters and performance characteristics of a backward curved centrifugal fan 934g that may be employed in some embodiments of the present specification. The figure also illustrates line drawings of a side elevation 936g and a back side 938g of the fan 934g. Side elevation 936g shows a maximum thickness of the fan 934g, without its central shaft, to be approximately 110 cm. In some embodiments, the impeller material of fan 934g is made from propylene with glass-fiber reinforced and sheet-metal plate. The fan 934g is provided with thermal protection overload (TOP) that is wired internally. Fan 934g operates within a temperature range of −10° C. to 60° C., and weighs approximately 3.8 Kg. Referring to the table 930g and the graph 932g, the two curves illustrate variation in air flow (measured in m³/h) with pressure (measured in Pa).

FIG. 9H shows a table 930h and corresponding graph 932h describing operational parameters and performance characteristics of a backward curved centrifugal fan 934h that may be employed in some embodiments of the present specification. The figure also illustrates line drawings of a side elevation 936h and a back side 938h of the fan 934h. Side elevation 936h shows a thickness of the fan 934h, without its central shaft, to be approximately 63.7 cm. In some embodiments, the impeller material of fan 934h is made from plastic with glass-fiber reinforced. Fan 934h operates within a temperature range of −10° C. to 60° C. Referring to the table 930h and the graph 932h, a curve 940h illustrates variation in air flow (measured in m³/h) with pressure (measured in Pa).

FIG. 9I shows a table 930i and corresponding graph 932i describing operational parameters and performance characteristics of a backward curved centrifugal fan 934i that may be employed in some embodiments of the present specification. The figure also illustrates line drawings of a side elevation 936i and a back side 938i of the fan 934i. Side elevation 936i shows a maximum thickness of the fan 934i, without its central shaft, to be approximately 60.5 cm. In some embodiments, the impeller material of fan 934h is made from plastic with glass-fiber reinforced. Fan 934i operates within a temperature range of −10° C. to 60° C. Referring to the table 930i and the graph 932i, a curve 940i illustrates variation in air flow (measured in m³/h) with pressure (measured in Pa).

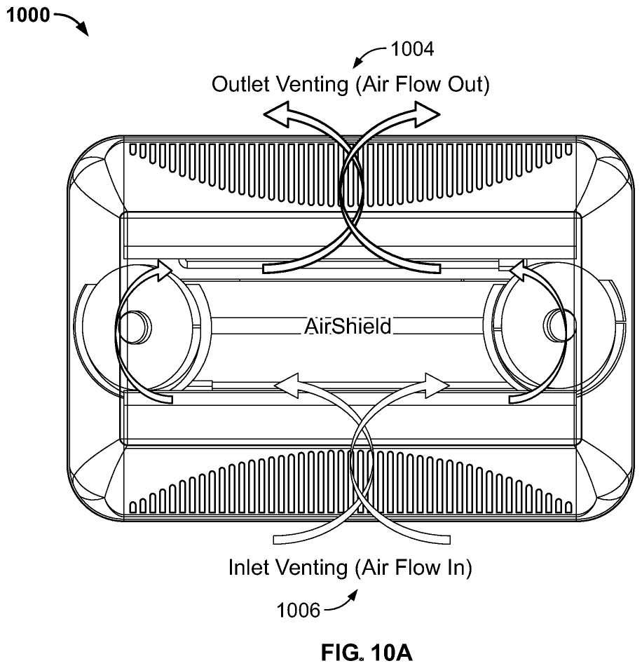

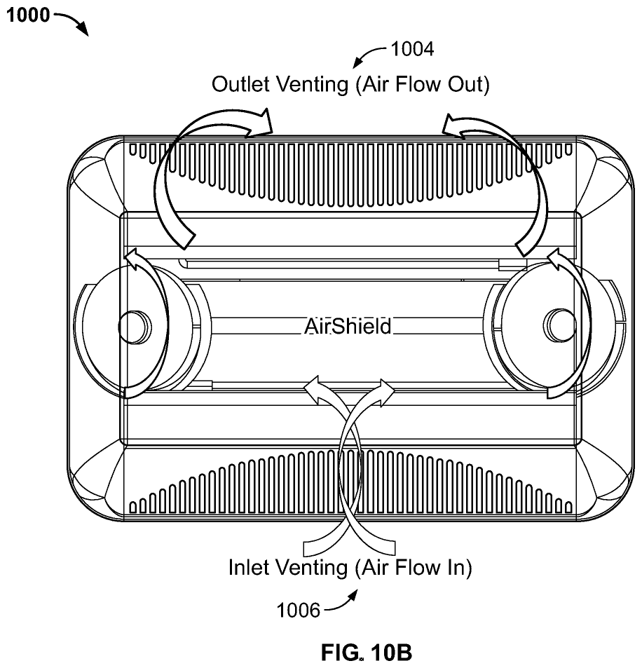

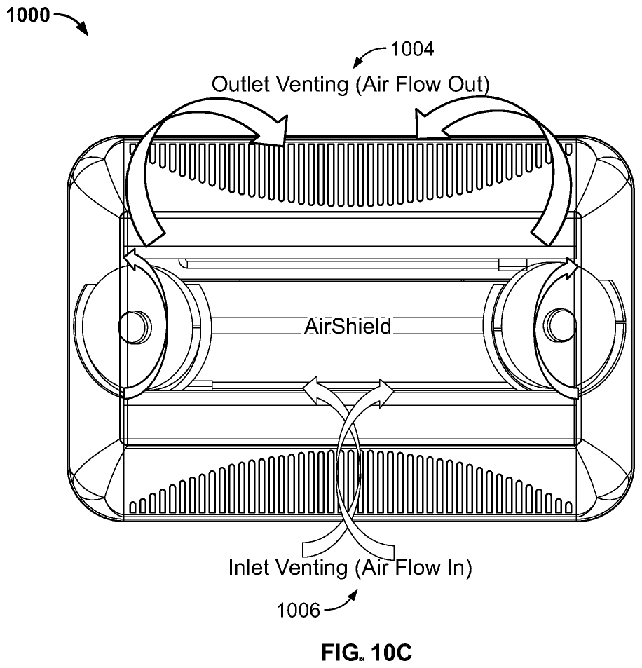

FIG. 9C is an exploded view of a first shroud assembly 910a and a second shroud assembly 912b for housing a fan or blower in accordance with some embodiments of the present specification. First shroud assembly 910a includes a bottom portion 910b and a top portion 910t. Second shroud assembly 912a includes a bottom portion 912b and a top portion 912t. The fan shrouds 910a, 912a are employed to redirect air generated by respective fans 910, 912. By using the shrouds, and as described below with respect to FIGS. 10A, 10B, and 10C, the two fans can spin in the same or opposite direction to create a turbulent air flow. In addition, in using more than one fan (the first fan 910 and the second fan 912), the system of the present specification is able to achieve adequate and optimal air treatment with a smaller footprint. Further, the fans are advantageously positioned so that each fan has an additive effect. By placing two fans on opposing sides of each other, each fan will take in its own air. Thus, if each fan has a capacity of 200 CFM, the total capacity of the two fans is 400 CFM. In contrast, stacked fans only serve to augment the capacity of each fan. Thus, in an example with stacked fans, if each fan has a capacity of 200 CFM, the total capacity will only be 200 CFM and there is no additive effect. If one fan in a stacked configuration is not operating to its full capacity, the other fan will only augment up to the total capacity. The use of two fans enables the creation of a turbulent flow within the two air chambers, allowing for better mixing of ions and better and more uniform exposure to UV-C.

In an embodiment, the room air flow management system of the present specification generates less than 78 dB of noise when operating at an air flow rate of greater than 800 CFM, as measured at a distance of 3 feet or 1 m from the system. In an embodiment, the room air flow management system of the present specification generates less than 75 dB of noise when operating at an air flow rate ranging from 400-800 CFM, as measured at a distance of 3 feet or 1 m from the system. In an embodiment, the room air flow management system of the present specification generates less than 65 dB of noise when operating at an air flow rate ranging from 100-200 CFM, as measured at a distance of 3 feet or 1 m from the system. In embodiments, the room air flow management system of the present specification radiates less than 30 dBuV/m of electromagnetic noise in the range of 30 MHz to 230 MHz and <37 dBuV/m in the range of 230 MHz to 1 GHz.

Referring back to FIG. 9A, control panel 914 is included. FIG. 9J is a front view 902j and a back side perspective view 904j of a control panel 914 used for operating the room air management system 900 in accordance with some embodiments of the present specification. The back side of control panel 914 is connected to the electrical circuits corresponding to the interface shown on front view 902j. The exemplary illustration shows LED indicators 906j emit light for each corresponding function that is in operation and shown on the control panel 914. Some of the functions on control panel 914 are accompanies with buttons or knobs 908j that enable control of the associated function. In some embodiments, buttons 908j are provided for functions such as selection of a run time that is preset in the room air management system 900. Examples of preset run times may include times of 6 hours, 12 hours, 18 hours, and continuous. LED indicators 906j indicate the selected option of run time. Another button 908j may enable reset of the selected run time. In embodiments, buttons 908j are additionally provided to select a mode for operating a fan. The options for fan mode may include turbo operation and normal or light operation (whisper mode). An LED indicator may indicate the need to replace filters of system 900. A button 908j to reset this indication is provided to disable the indication once the filter has been replaced.

Room air management system 900 includes at least one light source 920, whereby filtered air is exposed to light. In embodiments, filtered air is exposed to UV-C light, via the at least one light source 920, both directly and indirectly (via reflection) at a dosage level. In embodiments, the UV chamber is coated with a reflective coating. In embodiments, the coating has a reflectivity of 80% or higher. In an embodiment, aluminum is employed. In alternate embodiments, plastic coated with a UV reflective paint or a UV reflective liner, such as a plastic coated with aluminum or PFTE sheet liners may be employed. In another embodiment, the UV chamber is coated with a photocatalytic agent such as TiO₂.

In embodiments, the dosage level ranges from 0.5 mJ/cm² to 50 mJ/cm². In embodiments the system includes at least 1 UV-C light source. In embodiments, the system may include a UV-A or UV-B light source. In embodiments, the system may include a light source having a wavelength ranging between 100 nm and 400 nm. It should be noted that, in embodiments, any number of and type of light sources may be employed and the number of sources and/or bulbs is dependent upon the wattage of each individual bulb to meet the dose requirement. In embodiments, room air management system includes an electronics assembly 930, described in greater detail below may house the control electronics, an AC line filter, an AC/DC converter and UV-C ballasts.

FIG. 9B is a perspective view of a back interior portion of a room air management system 900, in an embodiment of the present specification, showing internal components. As shown in FIG. 9B, the system includes four light sources 920 (two of which were hidden behind filters in FIG. 9A), first fan shroud 910a, second fan shroud 912a, control panel 914, and electronics assembly 930.

In some embodiments, an ionizer (not shown), is deployed within at least one of the filter chambers or the UV-C chamber to aid with sanitization, VOC removal, and particulate filtration. In embodiments, the ionizer produces between 1 million and 1 billion ions/cc of air and generate only negative or both negative and positive ions. Within the chamber, the ionizer enhances the particulate filtration of the filters, kills airborne pathogens, and kills pathogens that adhere to the outer surface of the inlet filter thus minimizing the risk of infection while handling the filter during a filter change process. Further, filter decontamination allows for the safe disposal of filters after use. The ions generated within the air management system are generated downstream (post travel through) the outlet filter and also released into the room with the filtered air enabling germicidal functionality/activity in the room air outside of the air management system. The generated ions may also settle onto surfaces in the room to kill germs present on these surfaces using electroporation or cell wall/membrane damage. The ionizer uses an input current of ≤10 A, input power of <10W and an input voltage of ≤250V and generates an output voltage of >1.0 KVDC. The ion emitters are preferably made of carbon fibers, however steel emitters can also be used in certain circumstances. The carbon brush ionizer affords higher efficiency and low ozone performance due to its thin and/or multi-edged electrodes. The ionizers produce ≤1 PPM of Ozone.

In embodiments, the room air management system of the present specification generates <0.1 ppm of ozone. In embodiments, a room air management system of the present specification that is capable of purifying air at a rate of 1000 CFM reduces the background ozone concentration in a 800 CF test chamber by >50% in ≤5 minutes. In embodiments, a room air management system of the present specification that is capable of purifying air at a rate in a range of 500 to 700 CFM reduces the background ozone concentration in a 400 CF test chamber by >50% in ≤5 minutes. In embodiments, a room air management system of the present specification that is capable of purifying air at a rate in a range of 100 to 200 CFM reduces the background ozone concentration in a 100 CF test chamber by >50% in ≤5 minutes.

FIGS. 10A, 10B, and 10C represent front view illustrations of a room air management system showing a non-linear directionality of internal air flow. In each embodiment (shown in each of FIGS. 10A, 10B, and 10C), room air management system 1000 has an upper vent 1004, which serves as an air outlet, from which air flows out and a lower vent 1006 which serves as an air inlet through which air flows in. The directionality of the air flow is such that the air flow is non-linear or non-laminar, which creates turbulence, thus allowing for particles in the air to mix with ions generated by an ionizer or the PCO/PECO filter (both of which are described above) with a greater degree of efficiency. The ions serve to both create radicals that kill pathogenic particles and create charged particles that cause dust particles to clump. When dust particles clump, the dust filter is more efficient, so that the dust does not clog the high filtration efficiency filter at the outlet, which is a MERV filter or HEPA filter. In addition, the turbulent flow helps create more uniform UV exposure within the volume and a more uniform air flow across the length of the inlet and outlet filters. In an embodiment, input air is circulated through an internal volume, a filter, and a UV light source, using the fans/blowers, it is output as sanitized/purified air. The air flow is optimized to have a relatively uniform flow across the bottom filter and the top filter (+/−25%) both to maximize the filter surface area for filtration as well as keep the exposure time of the air in the UV-C in the system relatively similar (+/−25%).

As shown in FIGS. 10A and 10C, the two fans/blowers rotate in opposite directions causing the droplets suspended in the air to collide with each other or to collide with the internal walls of the system creating a non-linear, turbulent air flow, which allows for the ionizer-generated or PCO/PECO-generated ions to mix with droplets. Additionally, turbulent airflow allows for a more uniform average UV exposure to suspended aerosol droplets. FIG. 10B illustrates one or more fans rotating in the same direction, however, the air bouncing off the internal walls collides with air coming directly out of the fan/blower to create a non-linear turbulent air flow. In each of the embodiments shown in FIGS. 10A, 10B, and 10C, the air from the first fan or blower collides with the air from the second fan or blower to create a non-linear or turbulent air flow.

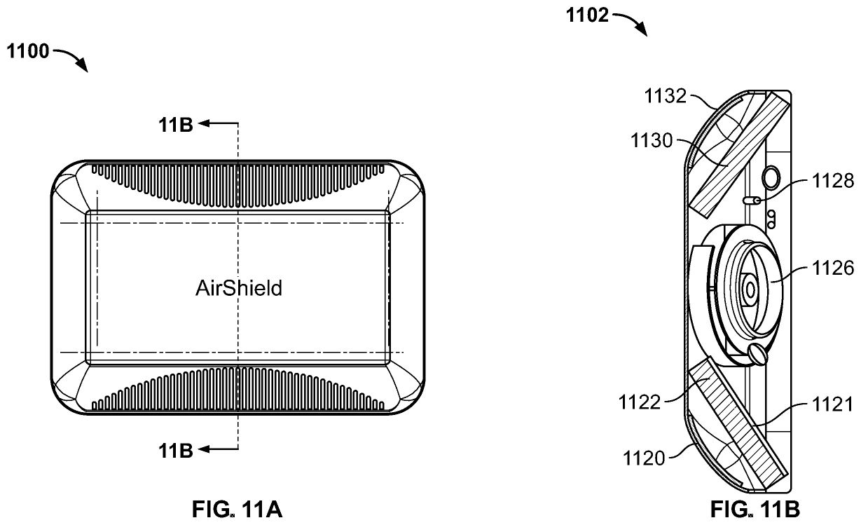

FIG. 11A is a front elevation view of an exemplary room air management system of the present specification 1100, showing a cross-section A-A 1102, which is shown in an exploded view in FIG. 11B. It should be noted that cross-section 1102 represents a first half of the room air management system. In operation, external air is drawn into the unit from an area of the room most proximate to the floor and most distal from the ceiling. In another embodiment, based on the native airflow in the room, external air can be drawn into the unit from an area of the room most proximate to the ceiling and most distal from the floor. In enclosed spaces, where the native flow of air pulls particles/droplets/aerosols in the air toward the ceiling (for example, due to a ceiling mounted HVAC return) it may be desirable to draw air from the upper two-thirds of the room. The input air is filtered using at least one inlet filter 1122, positioned in a first chamber. In embodiments, filter 1122 is employed to remove dust. In embodiments, filter 1122 is a MERV 7 or higher filter. In optional embodiments, a third filter 1120 is employed where the third filter may be an activated charcoal filter. In some embodiments, first filter 1122 and third filter 1120 are combined into a single unit.

In an embodiment, a second filter 1121 is employed and may be a photocatalytic filter. In embodiments, the photocatalytic filter may be fabricated from TiO₂ or any other PCO/PECO material as is known in the art. In embodiments, the filters 1120, 1121, and 1122 reside within a first chamber of the room air management system. In embodiments, the PCO/PECO filter is formed in a honeycomb mesh pattern, similar to that of a window screen. In embodiments, the TiO₂ coating is “activated” by a UV light source, as described below, creating radicals and thus, killing any pathogen contained in air that flows through the PCO/PECO filter. The filter design is optimized to maximize the surface area of the filter in the smallest volume while maximizing the exposure to filter surface to the air flow and UV light. In some embodiments, the PCO/PECO filter is placed in front of or upstream of the outlet MERV Filter 1130 and serves to shield the filter from direct UV exposure so that the outlet filter 1130 is only exposed to reflected UV-C, which has a much lower intensity than direct UV-C. In various embodiments, the filters 1122 and 1130 are at an angle of 0 degrees to 90 degrees, and preferably 0 degrees to 45 degrees, to the UV-C source to control the amount of direct UV-C exposure. In another embodiment, the face of the filter 1122 and 1130 is relatively parallel to the UV-C source to minimize or eliminate any direct UV-C exposure and the filter surface is only exposed to reflected UV-C. In one embodiment, the filter surface is exposed to <75% of direct UV-C dose. In another embodiment, the filter surface is exposed to <50% of the direct UV-C dose. In yet another embodiment, the filter surface is exposed to <25% of the direct UV-C dose. This allows for a delivery of a variable UV-C dose to the air in the chamber and filter surface to maintain an adequate cumulative UV-C dose to the air in the chamber and to the surface of the filter due to differing dwell time for pathogens in the air versus on the filter surface. This also, allows for minimizing the UV-C exposure to the filter surface, so as to maintain the efficacy, integrity and life of the filter exposed to UV-C.

In an embodiment, the UV light source positioned in the second chamber serves to “activate” the PCO/PECO filter in conjunction with the TiO₂ coating. In embodiments, the light source is a UV-C light source. In embodiments, filtered air is exposed to UV-C light, via at least one light source, in the second chamber (both directly and indirectly via reflection using a reflective surface as described above) at a first dosage. In embodiments, the first dose ranges from 0.5 mJ/cm² to 50 mJ/cm². In embodiments the second chamber includes at least one UV-C light source. In embodiments, the second chamber may include a UV-A or UV-B light source. In embodiments, the second chamber may include a light source having a wavelength ranging between 100 nm and 400 nm. It should be noted that, in embodiments, any number of and type of light sources may be employed and the number of sources and/or bulbs is dependent upon the wattage of each individual bulb to meet the dose requirement.

After a first exposure time with the UV light, the air may be forced or pushed to a third chamber using one or more fans or blowers (which, in an embodiment, is a high flow air pump) 1126. The directionality of air flow is discussed above with respect to FIGS. 10A, 10B, and 10C. The high flow air pump pushes the air into the second UV chamber, and provides a direct UV kill for any pathogen remaining on the surface. In embodiments, the third chamber includes at least one UV-C light source. In embodiments, the third chamber may include a UV-A or UV-B light source. In embodiments, the third chamber may include a light source having a wavelength ranging between 100 nm and 400 nm. It should be noted that, in embodiments, any number of and type of light sources may be employed and the number of sources and/or bulbs is dependent upon the wattage of each individual bulb to meet the dose requirement. Thus, the resultant, exposed air from the second chamber is exposed to UV light for a second “exposure” time at a secondary dosage. In embodiments, the secondary dosage ranges from 0.5 mj/cm² to 50 mj/cm². In embodiments, the first dose is equal to the second dose. In embodiments, the first dose is greater than the second dose. In embodiments, the second dose is greater than the first dose. The UV dose in each chamber is optimized to deliver between 1-6 log kill for airborne pathogens. In embodiments, the term “log kill” is used to refer to the percentage of reduction in concentration of an airborne pathogen (i.e. 1 log=90%, 2 log=99%, 3 log=99.9%, and so forth). Table 3 below represents exemplary operational parameters for the room air flow management system of the present specification to effectively reduce or eliminate MS2 bacteriophage.

TABLE 3

| | Air | | | | | Chamber/Room |
|---|---|---|---|---|---|---|
| System | Flow | Log | Duration/Time | Chamber/Room | Chamber/Room | Temperature |
| Example | (CFM) | Kill | (minutes) | Size (CF) | Humidity | (degrees Celsius) |
| 1 | >800 | >2 | 10 | 800 | 30-40% | 20 to 30° C. |
| 2 | 400- | >2 | 10 | 400 | 30-40% | 20 to 30° C. |
| | 600 | | | | | |
| 3 | 100- | >2 | 10 | 100 | 30-40% | 20 to 30° C. |
| | 200 | | | | | |
| 4 | >800 | >3 | 15 | 800 | 30-40% | 20 to 30° C. |
| 5 | 400- | >3 | 15 | 400 | 30-40% | 20 to 30° C. |
| | 600 | | | | | |
| 6 | 100- | >3 | 15 | 100 | 30-40% | 20 to 30° C. |
| | 200 | | | | | |
| 7 | >800 | >4 | 30 | 800 | 30-40% | 20 to 30° C. |
| 8 | 400- | >4 | 30 | 400 | 30-40% | 20 to 30° C. |
| | 600 | | | | | |
| 9 | 100- | >4 | 30 | 100 | 30-40% | 20 to 30° C. |
| | 200 | | | | | |

The air may then be filtered again using an outlet filter such as particulate filter 1130. In embodiments, filter 1130 is a MERV 13 or higher filter employed to remove any dust or aerosol particles that may potentially carry a virus or other airborne pathogen. In an embodiment, filter 1130 is a MERV 15 filter fitted with a carbon layer. The back side of the filter may be exposed to and sanitized using a light source. In embodiments, the light source is a UV-C light source. In embodiments, the UV-C light source is housed within second chamber 1128. In various embodiments, the dose/sec of UV-C being delivered to the filter surface is less than the dose (dose/sec) of UV-C being delivered to the air in the UV-C chamber by at least 50%.

In embodiments, any pathogen(s) that may be trapped on particle filter 1130 are exposed to OH and superoxide (O₂⁻) radicals created by the PCO/PECO filter after irradiation with UV-C light, which will kill any residual pathogens in the system. The PCO/PECO also results in degradation of volatile organic compounds (VOCs) in the air. In some embodiments of the present specification, in operation, the destructive efficiency for killing MS2 Bacteriophage present on the outlet filter is >99.9% at ≤30 minutes and >99.99% at ≤60 minutes. In some embodiments, a negative ion generator, bipolar ion generator or plasma ion generator can be used to accomplish this function.

In optional embodiments, the air is passed through a second carbon or charcoal filter 1132 prior to being allowed to exit near the upper portion of the room. In some embodiments, the carbon or charcoal filter is incorporated into the particulate filter 1130. In some embodiments a negative ion or bipolar plasma ion generator is installed downstream (post) a charcoal filter to release the ions into the room along with the filtered air providing a “fogging solution” for disinfecting air and surfaces.

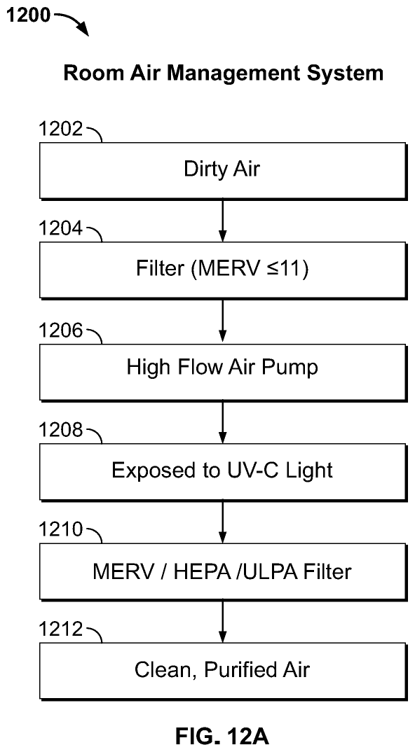

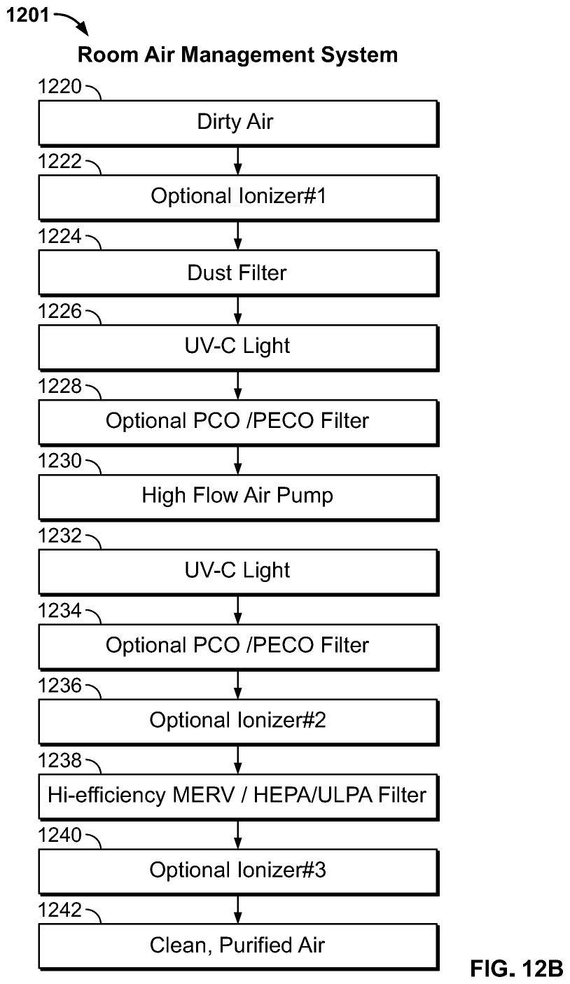

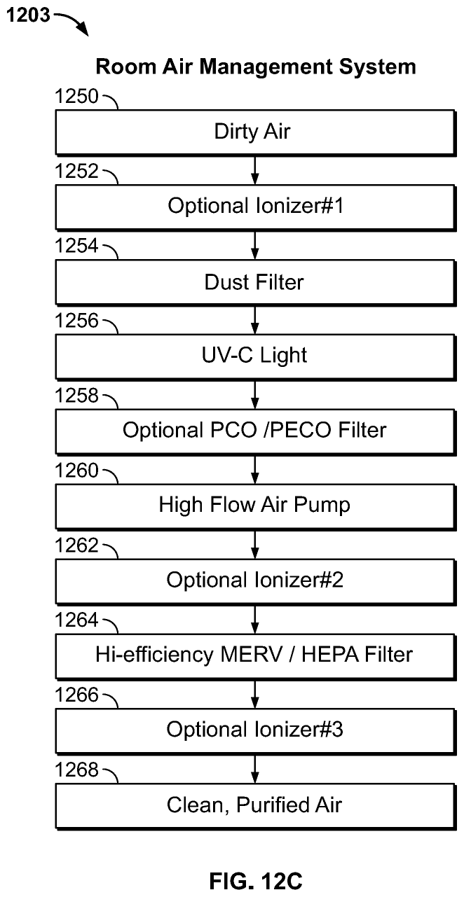

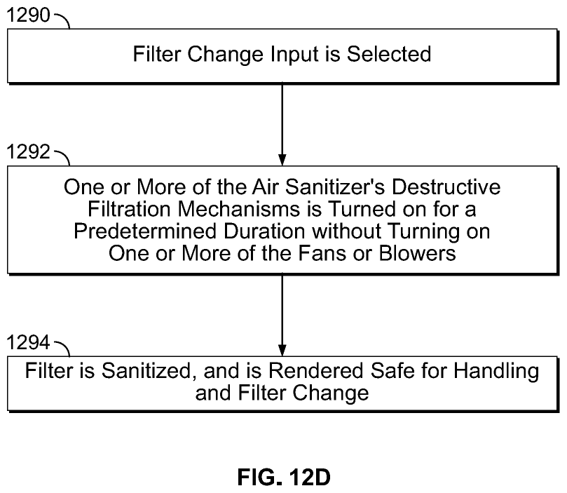

FIG. 12A is a schematic block flow diagram 1200 illustrating an operational flow of air through a room air management system in accordance with some embodiments of the present specification. In step 1202, dirty air is channeled into the room air management system of the present specification. In step 1204, the dirty air is passed through a first low-efficiency (MERV ≤12) filter to remove dust and particulate matter. In step 1206, the filtered air flows through at least one fan, which, in embodiments is a high flow air pump or backward curved centrifugal fan, where the filtered air is subsequently exposed to UV-C light in step 1208. In step 1210, the air that is exposed to UV-C light is passed through a second high-efficiency (MERV≥12) filter and the resultant clean air is then routed out of the air management system and into the room or area in which it was installed in step 1212.

FIG. 12B is another schematic block flow diagram 1201 illustrating an operational flow of air through a room air management system in accordance with some embodiments of the present specification. In step 1220, dirty air is channeled into the room air management system of the present specification and is optionally exposed to an ionizer in step 1222. In step 1224, the dirty air is passed through a first filter to remove dust and particulate matter. In step 1226, the filtered air is subsequently exposed to a first UV-C light. In step 1228, the air that is exposed to the first UV-C light is optionally passed through a second filter, which in an embodiment is a photocatalytic filter such as a PCO or PECO filter. The treated air is then passed through a fan, which in an embodiment, is a high flow air pump or backward curved centrifugal fan, in step 1230. In step 1232, the air is routed, by the high flow air pump, to a second UV-C light source where it is exposed to the UV-C light for a predetermined time period. In step 1234, the air that is exposed to the second UV-C light is optionally passed through a third filter, which in an embodiment is a photocatalytic filter such as a PCO or PECO filter. The resultant air is then optionally exposed to an ionizer in step 1236. The ionized air is then passed through, in step 1238, a fourth filter, which is a high-efficiency MERV/HEPA/ULPA filter. The resultant air is then optionally exposed to an ionizer in step 1240. In step 1242, the resultant clean air is then routed out of the air management system and into the room or area in which it was installed.

FIG. 12C is yet another schematic block flow diagram 1203 illustrating an operational flow of air through a room air management system in accordance with some embodiments of the present specification. In step 1250, dirty air is channeled into the room air management system of the present specification and is optionally exposed to an ionizer in step 1252. In step 1254, the dirty air is passed through a first filter to remove dust and particulate matter. In step 1256, the filtered air is subsequently exposed to a first UV-C light. In step 1258, the air that is exposed to the first UV-C light is optionally passed through a second filter, which in an embodiment is a photocatalytic filter such as a PCO or PECO filter. The treated air is then passed through a high flow air pump, in step 1260. In optional step 1262, the air is routed, by the high flow air pump, and optionally exposed to an ionizer. If the air is not passed through the ionizer, the air is routed in step 1264, by the high flow air pump, through a third filter which is a high-efficiency MERV/HEPA filter. In optional step 1266, the air is routed to an ionizer and exposed to an ionizer. In step 1268, the resultant clean air is then routed out of the air management system and into the room or area in which it was installed. In another embodiment, the high flow air pump 1260 is before step 1256 and 1258.

In some embodiments of the present specification, in operation, the destructive efficiency for killing MS2 Bacteriophage in a single pass test was ≥99.99%. In other embodiments of the present specification, in operation, the destructive efficiency for killing MS2 Bacteriophage in a single pass test was shown to be ≥99.9%.

In embodiments, the room air management system of the present specification draws less than 12 A of current when powered from a conventional 120 VAC power line.

Its desirable to have high efficiency, a small footprint, and a low noise level in a room air management system. Various room air management system operational characteristics and efficiency characteristics, as measured by the time to ≥4 log reduction in MS2 bacteriophage concentration in a 600 CF aerosol chamber are listed in Table 4 below.

TABLE 4

| | Air Flow | Noise | |
|---|---|---|---|
| Unit Volume (inch³) | (CFM) | (dB) | Time (minutes) |
| ≤1800 | 1200 | <80 | ≤15 |
| ≤1400 | 600 | <75 | ≤30 |
| ≤1000 | 300 | <65 | ≤30 |

In embodiments, the filters employed in the room air management system of the present specification are disposable and/or replaceable. In embodiments, the room air management system of the present specification includes a smart mechanism that may be employed, at a minimum, for alerting an operator on filter health, for alerting the need for filter replacement, and for indicating when a filter is safe for handling after sanitization. In various embodiments, the filters deployed are UL 507 and/or UL 746C certified. FIG. 12D is a flow diagram showing steps of a method for changing a filter in accordance with some embodiments of the present specification. At step 1290, the operator selects the filter change option, either in response to an alert or the passage of a predetermined time period. At step 1292, one of more of the air sanitizer's destructive filtration mechanisms is activated. In embodiments, the destructive filtration mechanism is a UV light source and/or an ionizer as described above. In embodiments, when the destructive filtration mechanism is activated, the one or more fans or blowers are turned off or deactivated. This minimizes the entry of new contaminants that may settle on the filter. At step 1294, the system alerts when the filter is sanitized and is rendered safe for handling so that it can be disposed of and a new filter can be placed in the system.

In embodiments, the use of at least one smaller and thinner fan affords a smaller overall footprint of the room air management system of the present specification. In embodiments, the use of at least two smaller and thinner fans affords a smaller overall footprint of the room air management system of the present specification. Thus, in embodiments, the system of the present specification is optimized such that the amount of power and air flow required to treat the air is in a form factor that is similar to a flat screen TV.

In embodiments, the system has multiple sensors to monitor the functionality of the system. The sensors include one or more UV sensors to monitor the intensity of UV-C in the system. The sensors also include one or more flow sensors to measure the airflow through the system. The system has a pressure sensor to monitor the pressure inside the system in turn to measure the filter resistance and alerting the user that the filter needs to be changed. The system also has optional air quality sensors that can monitor the quality of air delivered by the system. Other sensors may include a laser particulate sensor, VOC sensor, HCHO sensor, CO sensor, CO₂ sensor, humidity sensor and an ozone sensor. Other air quality sensors known in the art can also be employed.

In embodiments, the room air management system of the present specification includes a proximity sensor for sensing the proximity of an individual or individuals which subsequently communicates with the room air management system of the present specification to adjust the speed of the airflow, thus reducing the overall sound level of the system.

In embodiments, room air management system of the present specification includes a density sensor for sensing the density of individuals in a space, which subsequently communicates with the room air management system of the present specification to adjust the speed of the airflow, thus altering the air delivery rate from the system. In embodiments, several sensors, as are known in the art, can be used to assess the density, including, but not limited to thermal modalities, chemical sensors, imaging modalities (such as a camera), Bluetooth, and noise detectors. In an embodiment, a carbon dioxide sensor may be employed to detect the CO₂ concentration in the indoor air via a non-dispersive infrared technology (NDIR). This type of detector measures the intensity of infrared light that can be correlated with the intensity of CO₂, which is described by Lambert-Beer's law. Thus, a change in a sensor signal reflects a change in gas concentration. The concentration of CO₂ in the enclosed air can be used to determine the density of individuals in any given space.

In embodiments, the room air management system of the present specification can be provided as an add-on device to work with an existing HVAC system, such as an air conditioning unit. In embodiments, the room air management system of the present specification can communicate with an existing HVAC system wirelessly or via an IoT or smart device system. Various information, such as indoor space dimensions, air requirements and other parameters may be input into the microprocessor of the air sanitizer. In embodiments where the air sanitizer is wirelessly connected to a device that is connected to or associated with an individual or individuals, the presence of that device may be detected by the room air management system, altering one or more functions of the system based on predetermined or preprogrammed parameters. In another embodiment, the air management system is installed at the inlet for an HVAC air handler, feeding clean sanitized air to the air handler which than circulates the air throughout the building via the existing duct system.

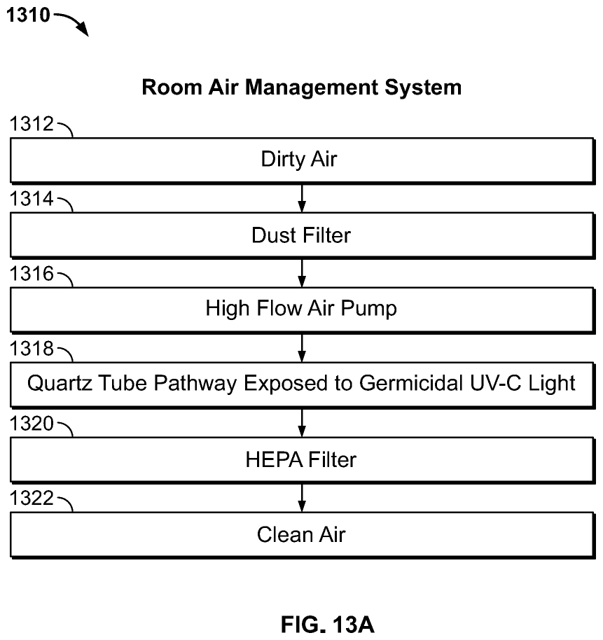

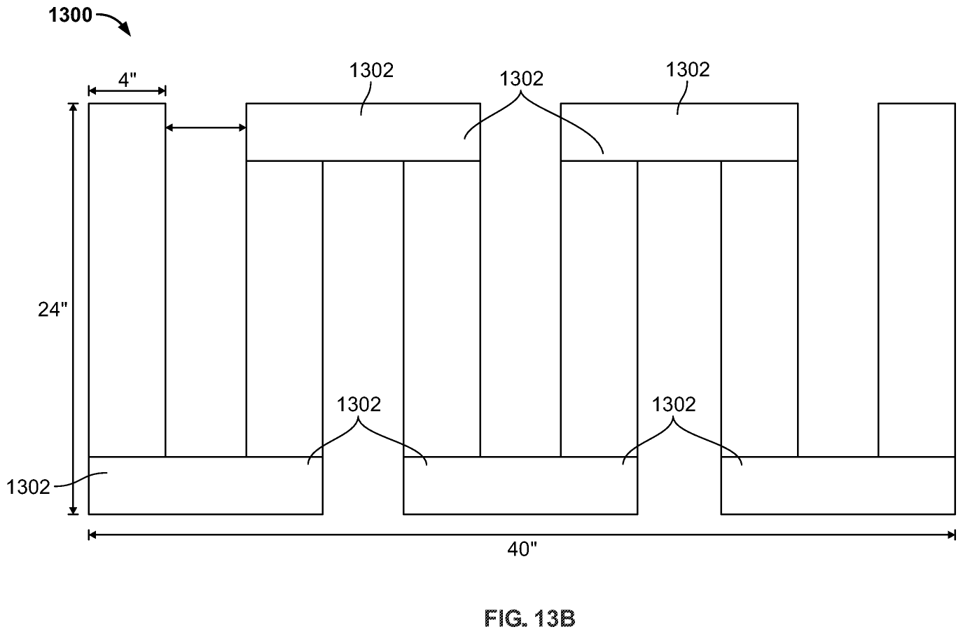

FIG. 13A is a block flow diagram of another embodiment of a room air management system employing UV filtration. In embodiments, the footprint of the system ranges from a capacity of 40 to 100 gallons and is preferably 60 gallons. In embodiments, the airflow is designed to range from 100 cfm (cubic feet/meter) to 2000 cfm or greater. As shown in FIG. 13A, the room air management system 1310 includes a dirty air source input (typically ambient air) 1312. Dirty air is passed through a dust filter 1314 and directed towards a high flow air pump 1316. From the high flow air pump, the air is then routed through a quartz tube pathway 1318 that is exposed to UV light and preferably germicidal UV light, such as UV-C light. The treated air is then directed through a HEPA filter 1320 and output via a clean air outlet 1322.

FIG. 13B is a schematic diagram of a non-linear hollow tube pathway 1300, in accordance with some embodiments of the present specification. The hollow tube pathway 1300 acts as a conduit for air flow, is made of quartz and includes a plurality of bends or turns 1302. The bent or non-linear configuration of the pathway 1300 enables an otherwise long tube to be accommodated within a small space while at the same time increasing an overall path of air flow within the small space.

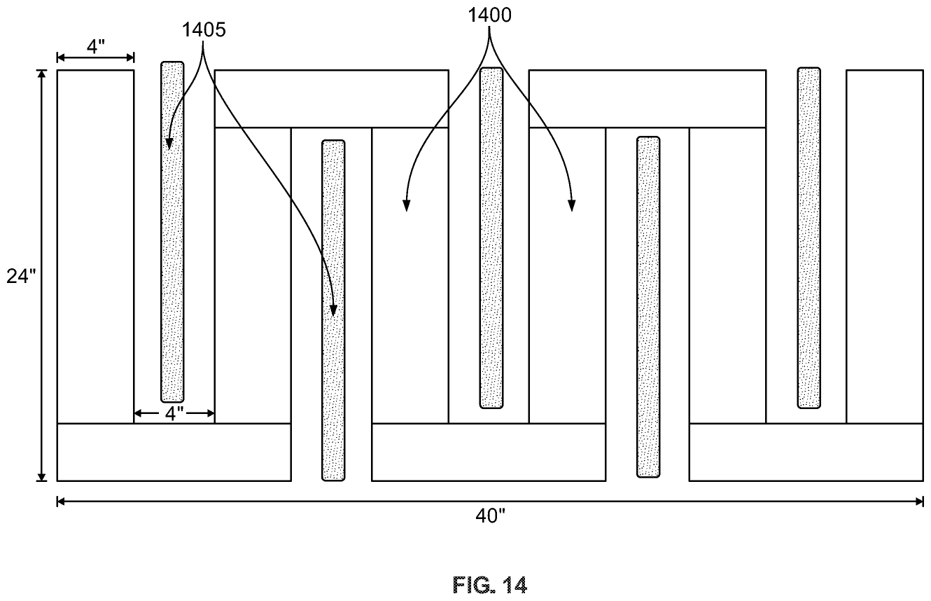

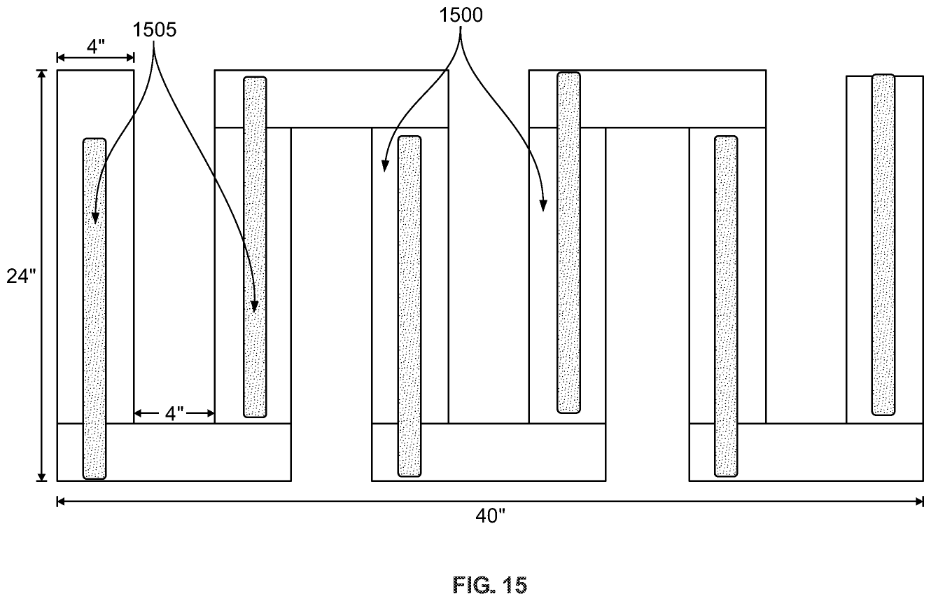

FIG. 14 illustrates a plurality of UV light sources 1405 positioned outside a non-linear hollow tube pathway 1400 (pathway 1300 of FIG. 13B) while FIG. 15 illustrates a plurality of UV light sources 1505 positioned within the non-linear hollow tube pathway 1500 (pathway 1300 of FIG. 13B), in accordance with some embodiments of the present specification. In embodiments, the tube pathway 1300 is fabricated from clear quartz that does not obstruct the UV radiation emanating from the plurality of UV light sources 1405. Referring to FIG. 15, an imaginary plane is defined by the source of UV-C, while the air moves in one direction compared to the plane and then moves in at least one 2nd direction relative to that plane, and subsequently moves in a third direction compared to that plane, all while being irradiated by the UV-C from that source.

Referring to FIGS. 13B, 14, and 15, the increased path of air flow through the non-linear pathway 1300 increases a time of exposure of the air flow (within the pathway 1300) to UV radiation generated by the plurality of UV light sources 1405, 1505.

In some embodiments, a desired UV exposure is of 50 uW/cm² for greater than 3 seconds and of 100 uW/cm² for greater than 1 sec. An increase in wattage and an increase in exposure time tend to increase the viral inactivation rate of UV-C. The non-linear air flow, within the pathway 1300, creates turbulence which slows the flow along the entire path of air flow, further increasing UV contact/exposure time. In some embodiments, the path of a portion of the air flow is at least 1.5 times longer, which is a relatively long linear dimension (length, width, height) of the pathway 1300. Hence, exposure time to UV-C is increased by at least two times that of exposure time with a linear flow along one of the longest linear dimension (length, width, height) of the pathway 1300.

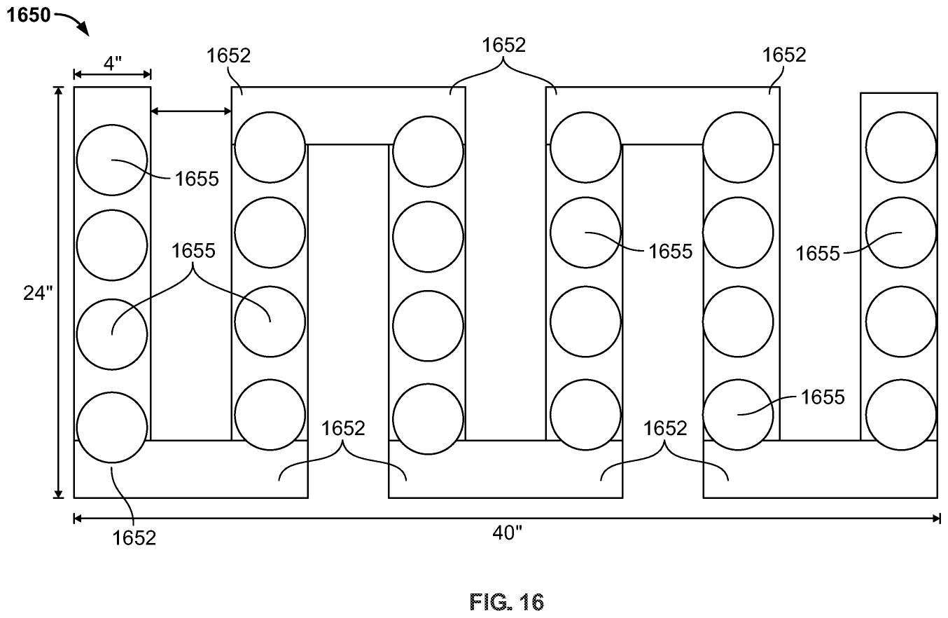

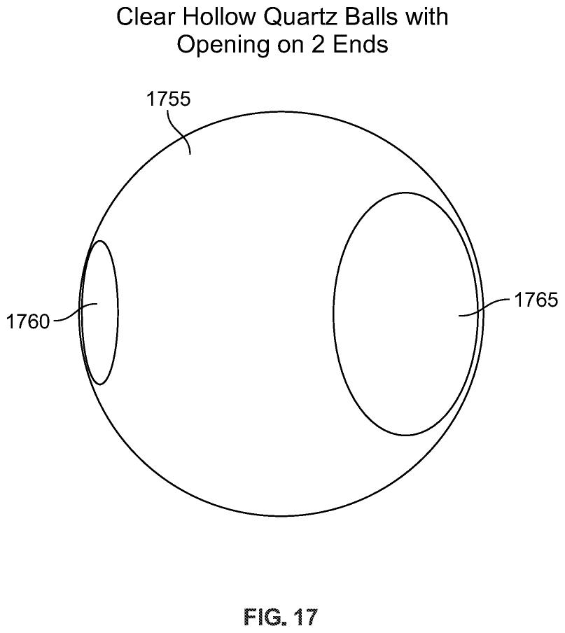

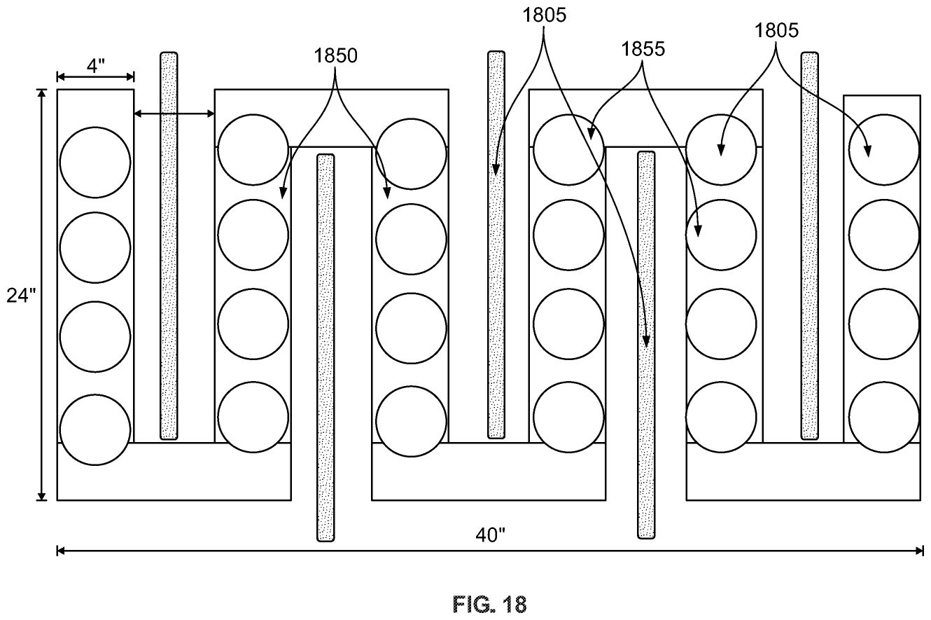

FIG. 16 is a schematic diagram of a non-linear hollow tube pathway 1650 incorporating a plurality of hollow quartz balls, in accordance with some embodiments of the present specification. The hollow tube pathway 1650 acts as a conduit for air flow, is made of quartz and includes a plurality of bends or turns 1652. A plurality of hollow quartz balls 1655 are positioned within the hollow tube pathway 1650. In some embodiments, the balls 1655 are substantially spherical in shape. As shown in FIG. 17, each ball 1755 has a first opening 1760 and a second opening 1765. Referring simultaneously to FIGS. 16 and 17, the balls 1655/1755 are oriented in such a way that air flowing within the pathway 1650 enters each ball 1655/1755 through the first opening 1760 and exits the ball 1655/1755 through the second opening 1765. In some embodiments, the first opening 1760 and the second opening 1765 are diametrically opposite to each other. In embodiments, the plurality of hollow quartz balls 1655/1755 increase resistance to air flowing within the pathway 1650, thereby creating turbulence and further increasing the path of air flow.

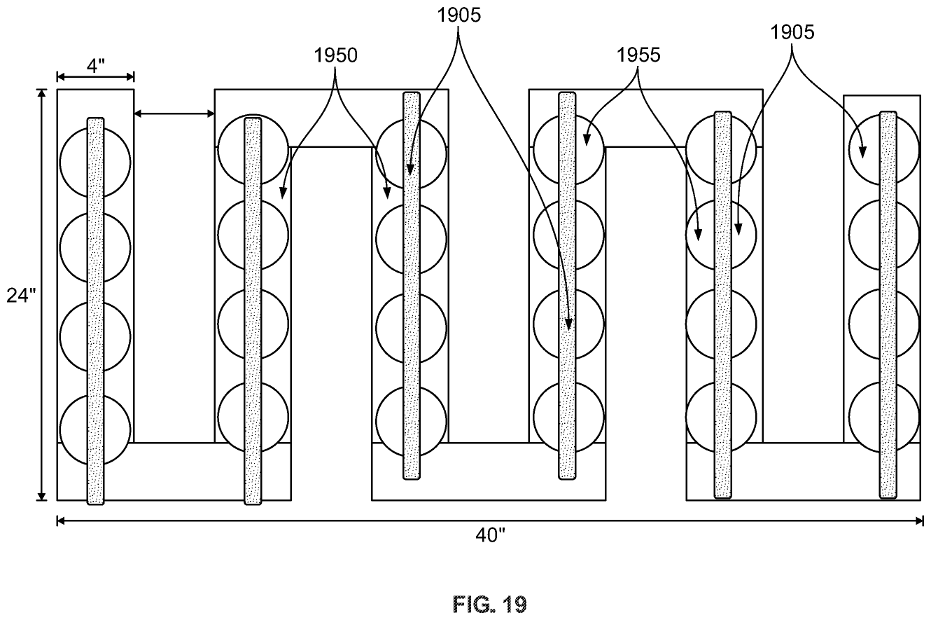

FIG. 18 illustrates a plurality of UV light sources 1805 positioned outside a non-linear hollow tube pathway 1850 (pathway 1650 of FIG. 16) while FIG. 19 illustrates a plurality of UV light sources 1905 positioned within the non-linear hollow tube pathway 1950 (pathway 1650 of FIG. 16), in accordance with some embodiments of the present specification. Also shown in FIGS. 18 and 19, the plurality of hollow quartz balls 1855/1955 (balls 1655 of FIG. 16) are positioned within the hollow tube pathway 1850/1950. In embodiments, the tube pathway 1850/1950 and the balls 1805/1905 are of clear quartz so as to not obstruct the UV radiation emanating from the plurality of UV light sources 1805/1905.

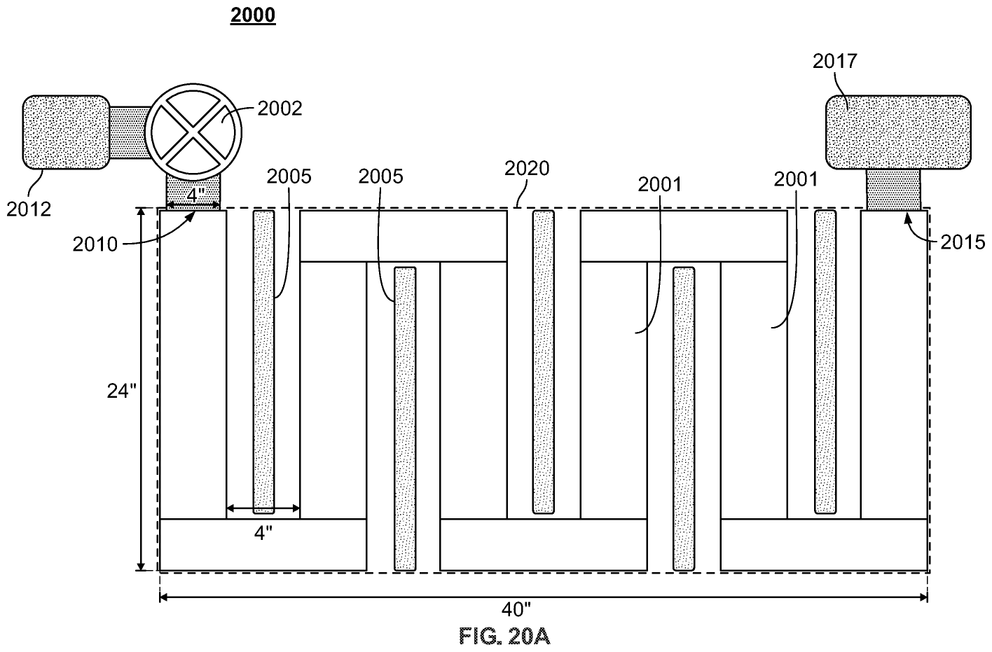

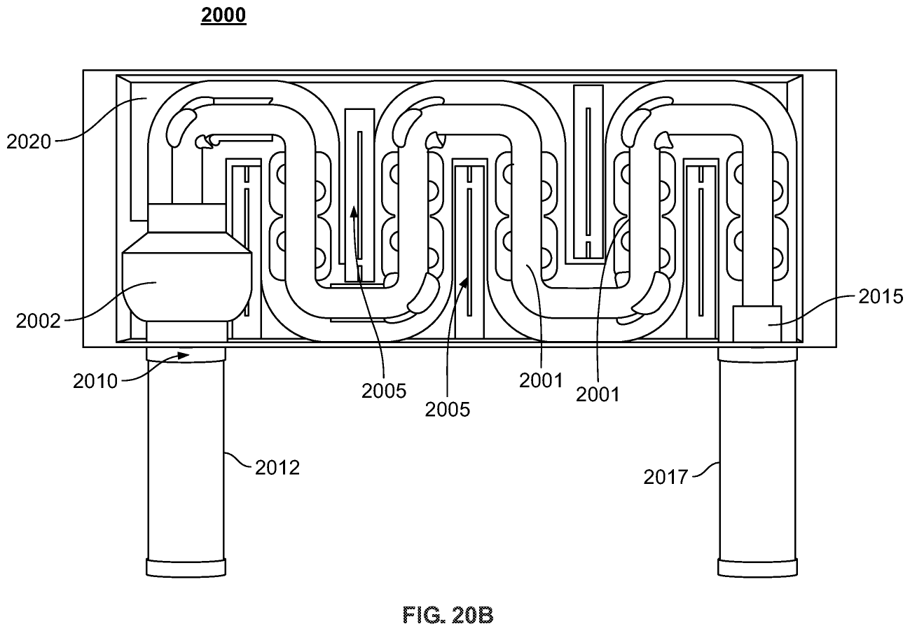

FIG. 20A is a schematic diagram while FIG. 20B shows a perspective view of a plurality of components of a room air management system 2000, in accordance with a first embodiment of the present specification. Referring now to FIGS. 20A, 20B, the system 2000 includes a non-linear hollow tube pathway 2001 with a plurality of UV light sources 2005 positioned outside the pathway 2001. In embodiments, the tube pathway 2001 is of clear quartz that does not obstruct the UV radiation emanating from the plurality of UV light sources 2005. A high-flow pump 2002 is positioned proximate an inlet port 2010 of the pathway 2001. The pump 2002 is configured to draw surrounding contaminated air through an intake dust filter 2012. The drawn air is then propelled through the pathway 2001 thereby exposing the contaminated air to radiation from the plurality of UV light sources 2005. Air sterilized by UV light exposure is eventually driven out of the pathway 2001, by the pump 2002, through an outlet port 2015 and subsequently through an outflow HEPA (High Efficiency Particulate Air) filter 2017.

In embodiments, a surface area of the intake filter 2012 is same or lesser than the outflow filter 2017 so as not to create a mechanical gradient to the flow of air.

In embodiments, the non-linear hollow tube pathway 2001 with the plurality of UV light sources 2005 is housed within an enclosure or chamber 2020. The enclosure or chamber 2020 acts as a UV protective casing and, in some embodiments, has a UV reflective lining or paint on its interior to increase effectiveness of the germicidal effect of the UV light. A low-Q Fabry-Perot cavity is created by coating the interior with a reflective material. In some embodiments, the UV reflective lining or paint includes reflective material such as, but not limited to, Germicide or Lumacept Bright.

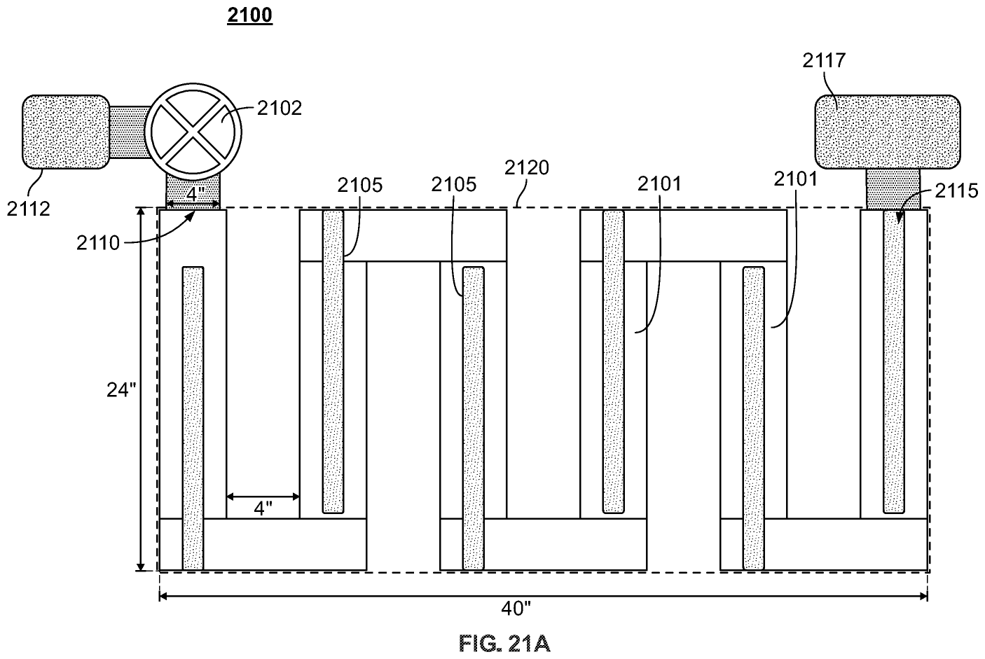

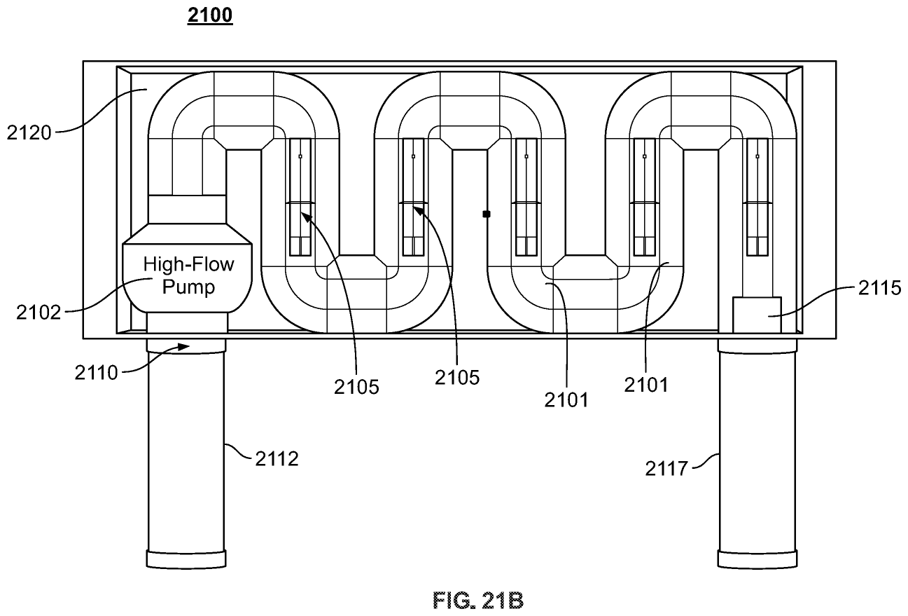

FIG. 21A is a schematic diagram while FIG. 21B shows a perspective view of a plurality of components of a room air management and filtration system 2100, in accordance with a second embodiment of the present specification. Referring now to FIGS. 21A, 21B, the system 2100 includes a non-linear hollow tube pathway 2101 with a plurality of UV light sources 2105 positioned within the pathway 2101. In embodiments, the tube pathway 2101 is of clear quartz that does not obstruct the UV radiation emanating from the plurality of UV light sources 2105. A high-flow pump 2102 is positioned proximate an inlet port 2110 of the pathway 2101. The pump 2102 is configured to draw surrounding contaminated air through an intake dust filter 2112. The drawn air is then propelled through the pathway 2101 thereby exposing the contaminated air to radiation from the plurality of UV light sources 2105. Air sterilized by UV light exposure is eventually driven out of the pathway 2101, by the pump 2102, through an outlet port 2115 and subsequently through an outflow HEPA (High Efficiency Particulate Air) filter 2117.

In embodiments, a surface area of the intake filter 2112 is same or lesser than the outflow filter 2117 so as not to create a mechanical gradient to the flow of air.

In embodiments, the non-linear hollow tube pathway 2101 with the plurality of UV light sources 2105 is housed within an enclosure or chamber 2120. The enclosure or chamber 2120 acts as a UV protective casing and, in some embodiments, has a UV reflective lining or paint on its interior to increase effectiveness of the germicidal effect of the UV light. A low-Q Fabry-Perot cavity is created by coating the interior with a reflective material. In some embodiments, the UV reflective lining or paint includes reflective material such as, but not limited to, Germicide or Lumacept Bright.

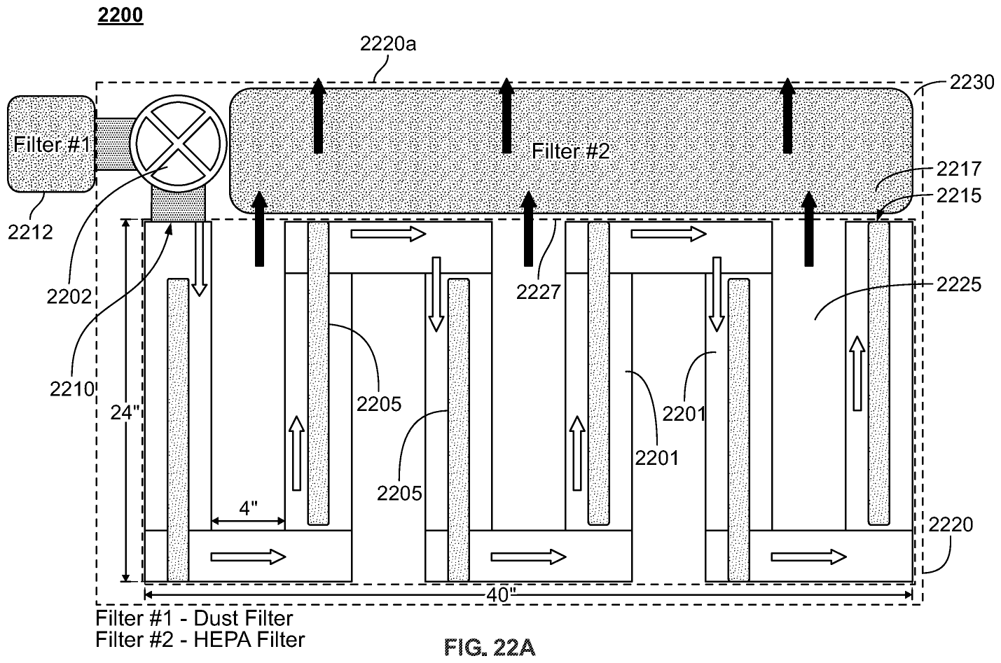

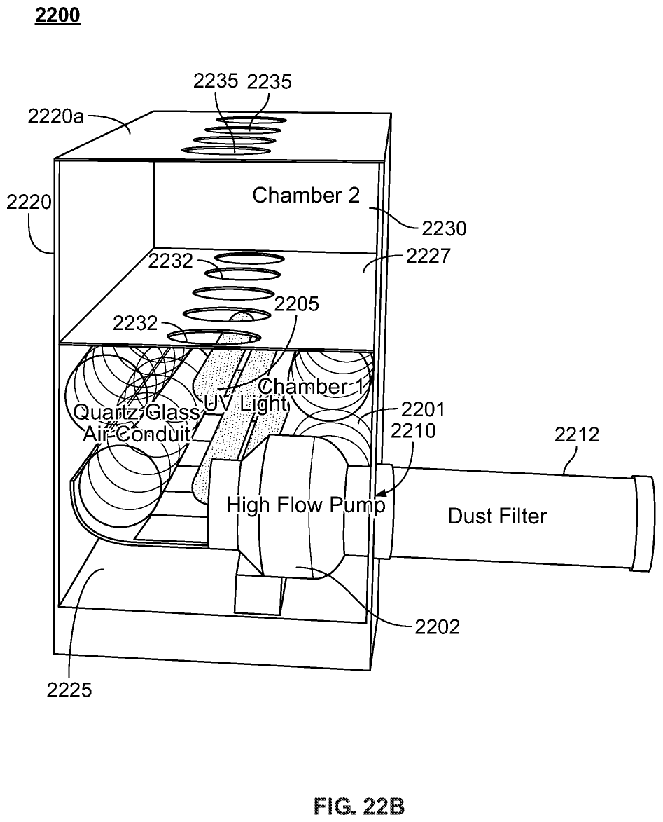

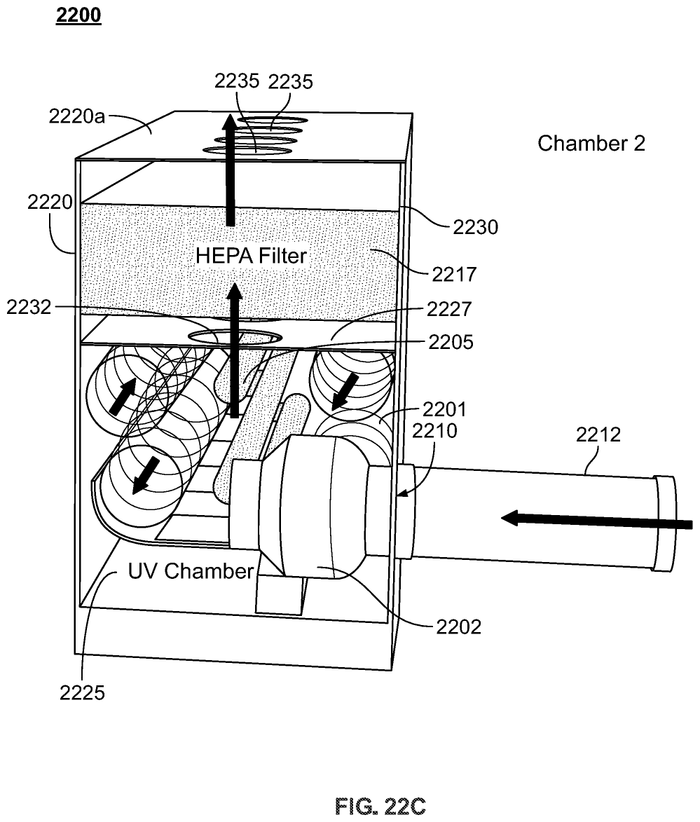

FIG. 22A is a schematic diagram while FIGS. 22B and 22C are perspective side views of a plurality of components of a room air management system 2200, in accordance with an embodiment of the present specification. Referring now to FIGS. 22A, 22B and 22C, the system 2200 includes a non-linear hollow tube pathway 2201 with a plurality of UV light sources 2205 positioned within the pathway 2201. In embodiments, the non-linear hollow tube pathway 2201 with the plurality of UV light sources 2205 is housed within a first chamber 2225 of an enclosure 2220 while an outflow HEPA filter 2217 (FIGS. 22A, 22C) is positioned within a second chamber 2230 of the enclosure 2220. In embodiments, the second chamber 2230 is positioned above the first chamber 2225. The first and second chambers 2225, 2230 are separated by a partition 2227. In some embodiments, the partition 2227 includes a plurality of openings 2232 (FIGS. 22B, 22C). The top surface or side 2220a of the enclosure 2220 also includes a plurality of openings 2235 (FIGS. 22B, 22C).

In embodiments, the tube pathway 2201 is of clear quartz that does not obstruct the UV radiation emanating from the plurality of UV light sources 2205. A high-flow pump 2202 is positioned proximate an inlet port 2210 of the pathway 2201. The pump 2202 is configured to draw surrounding contaminated air through an intake dust filter 2212. The drawn air is then propelled through the pathway 2201 thereby exposing the contaminated air to radiation from the plurality of UV light sources 2205. Air sterilized by UV light exposure is eventually driven out of the pathway 2201, by the pump 2202, through an outlet port 2215 (FIG. 22A) and into the first chamber 2225. The UV sterilized air released from the outlet port 2215 circulates in the first chamber 2225 and also flows into the second chamber 2230 via the plurality of openings 2232.

UV sterilized air flows through the outflow HEPA filter 2217 via the plurality of openings 2232 before being eventually released outside the enclosure 2220 via the plurality of openings 2235.

It should be appreciated that the sterilized air released from the outlet port 2215 and into the first chamber 2225 is further exposed to the UV radiation emanating from the plurality of UV light sources 2205. Additionally, the purified air circulating in the first chamber 2225 cools the plurality of UV light sources 2205 to ambient temperature ˜40+/−5 oC to increase the efficiency of the UV light sources 2205.

In some embodiments, the enclosure or chamber 2220 acts as a UV protective casing and, in some embodiments, has a UV reflective lining or paint on its interior to increase effectiveness of the germicidal effect of the UV light. A low-Q Fabry-Perot cavity is created by coating the interior with a reflective material. In some embodiments, the UV reflective lining or paint includes reflective material such as, but not limited to, Germicide or Lumacept Bright.

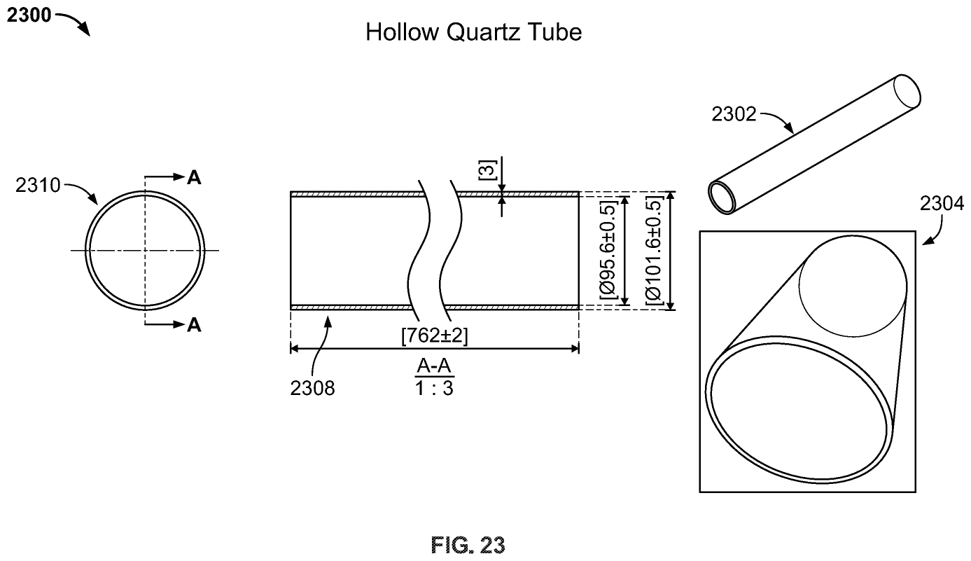

FIG. 23 shows a plurality of views of a hollow quartz tube 2300 that may be used to fabricate non-linear pathways for air flow, in accordance with some embodiments of the present specification. Images 2302 and 2304 show perspective views, image 2308 shows a longitudinal cross-sectional view while image 2310 shows a side cross-sectional view of the tube 2300.

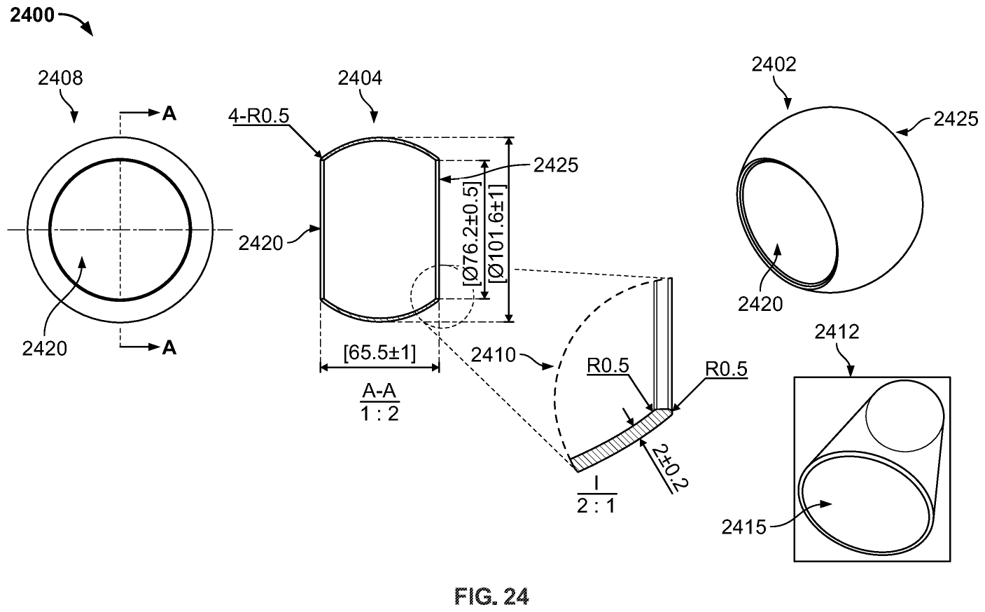

FIG. 24 shows a plurality of views of a hollow quartz ball or sphere 2400, in accordance with some embodiments of the present specification. The ball or sphere 2400 has a first opening 2420 and a second opening 2425 diametrically opposite the first opening 2420. Image 2402 shows a perspective view, image 2404 shows a first side view, image 2408 shows a second side view while image 2410 shows a partial cross-sectional view of the ball or sphere 2400. Image 2412 shows a hollow quartz tube 2415 within which a plurality of balls or sphere 2400 may be accommodated.

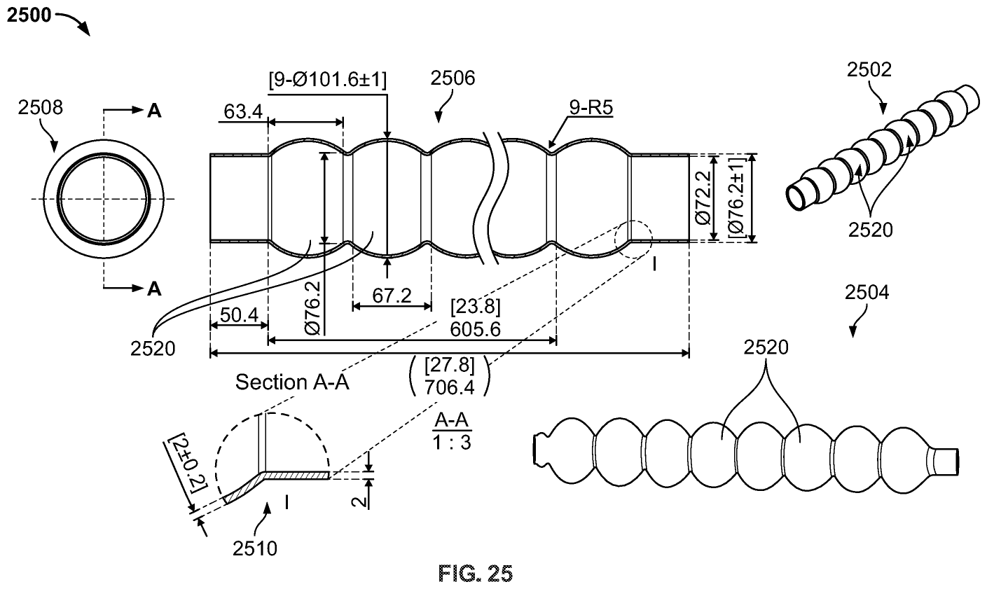

FIG. 25 shows a plurality of views of a beaded hollow quartz tube 2500 that may be used to fabricate non-linear pathways for air flow, in accordance with some embodiments of the present specification. Images 2502 and 2504 show perspective views, image 2506 shows a longitudinal side view, image 2508 shows a transverse side view while image 2510 shows a cross-sectional view of a portion of the tube 2500 at the junction of the output and the first beaded section. The tube 2500 has a plurality of beads 2520 formed on an outer surface along a length of the tube 2500.

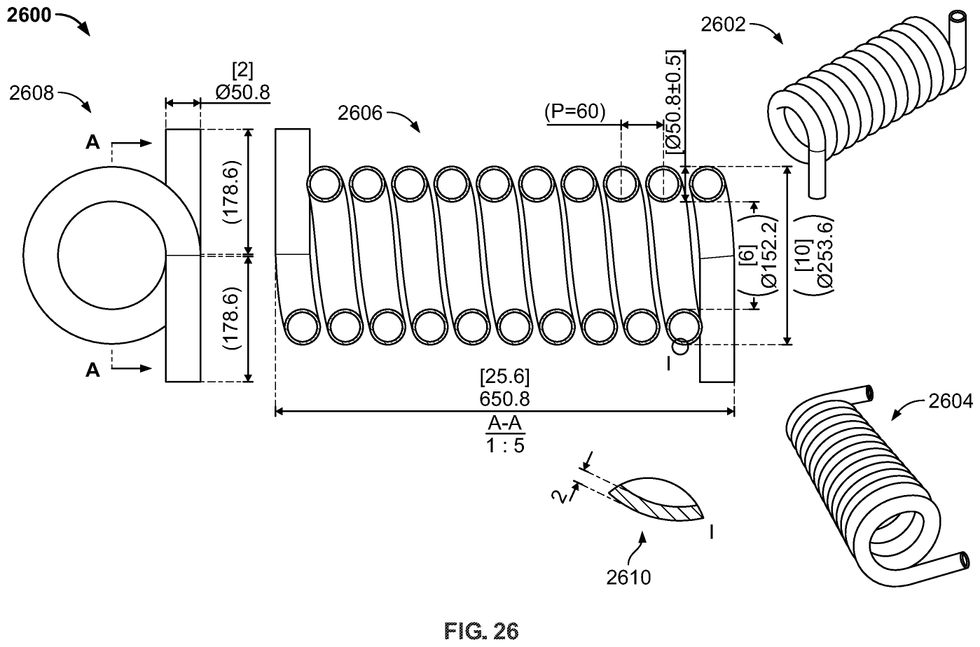

FIG. 26 shows a plurality of views of a spiral hollow quartz tube 2600 that may be used to fabricate non-linear pathways for air flow, in accordance with some embodiments of the present specification. Images 2602 and 2604 show perspective views, image 2606 shows a longitudinal cross-sectional view, image 2608 shows a side view while image 2610 shows a cross-sectional view of a portion of the tube 2600 at a coil turn. As shown, the tube 2600 is configured in the form of a spiral.

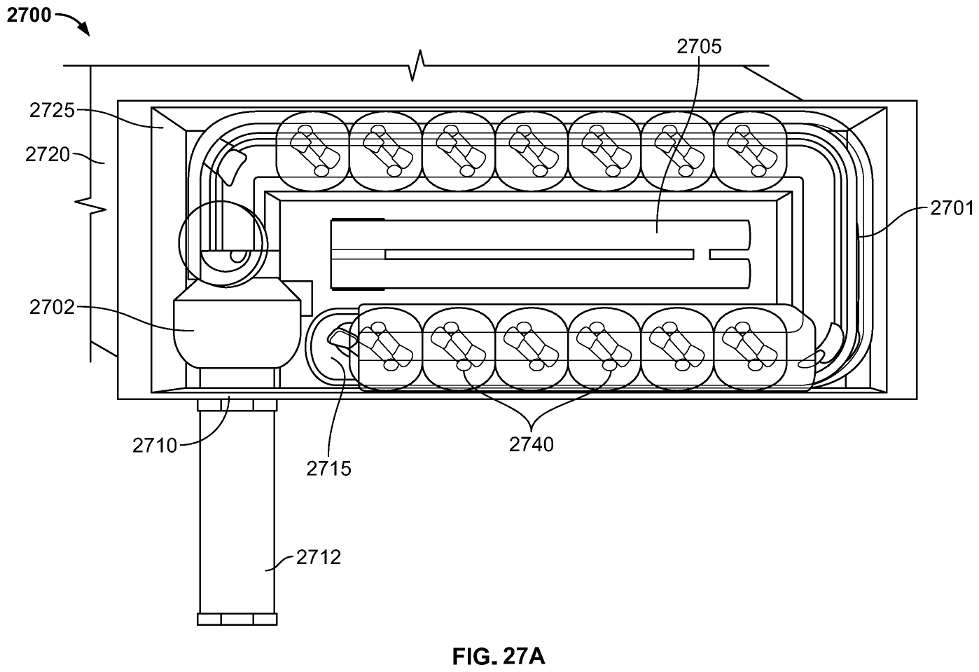

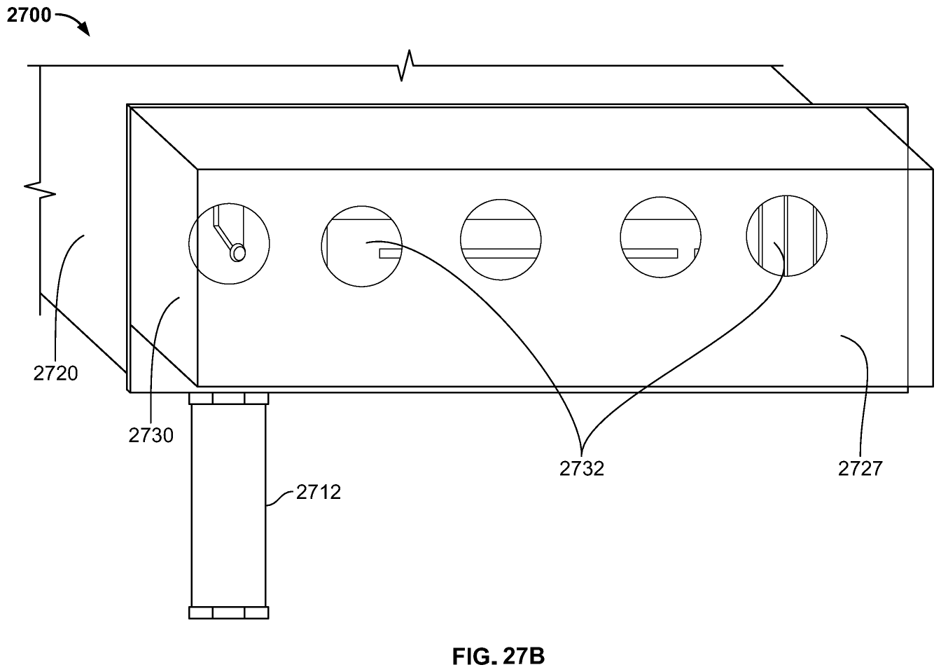

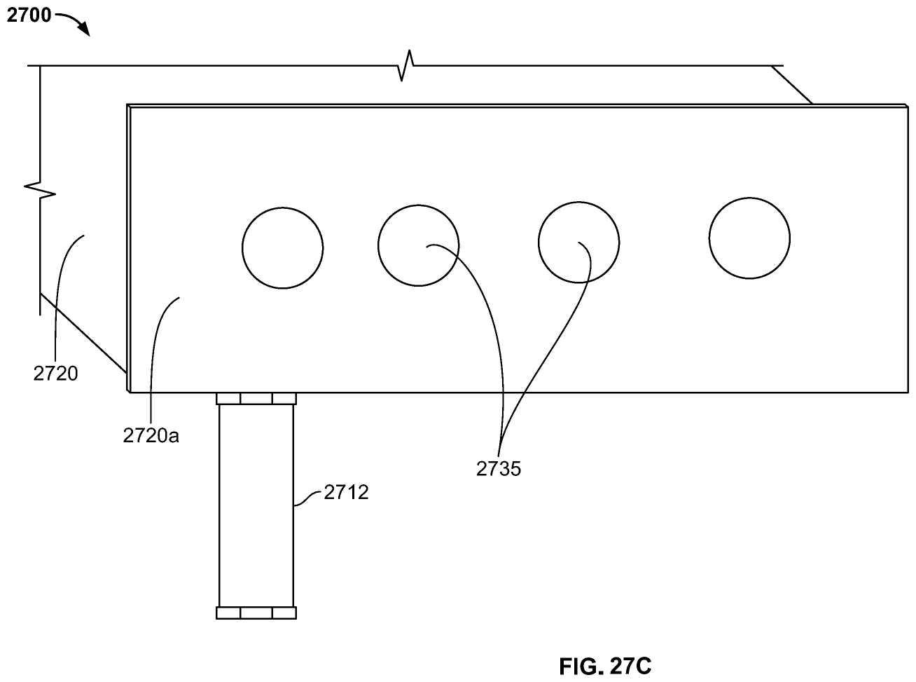

FIGS. 27A, 27B and 27C show perspective views of a plurality of components of a room air management system 2700, in accordance with some embodiments of the present specification. Referring now to FIGS. 27A, 27B and 27C, the system 2700 includes a non-linear hollow tube pathway 2701 with at least one UV light source 2705 positioned outside the pathway 2701. In accordance with an aspect, the pathway 2701 is configured to surround the at least one UV light source 2705. A plurality of hollow quartz balls or spheres 2740 (similar to the ones described with reference to FIGS. 38 and 47) are positioned within the pathway 2701.

In embodiments, the non-linear hollow tube pathway 2701 with the at least one UV light source 2705 is housed within a first chamber 2725 of an enclosure 2720 while an outflow HEPA filter (not shown) is positioned within a second chamber 2730 (FIG. 27B) of the enclosure 2720. In some embodiments, the second chamber 2730 is positioned adjacent to the first chamber 2725. The first and second chambers 2725, 2730 are separated by a partition 2727. In some embodiments, the partition 2727 includes a plurality of openings 2732 (FIG. 27B). A side surface 2720a of the second chamber 2730 also includes a plurality of openings 2735 (FIG. 27C).

In embodiments, the tube pathway 2701 is of clear quartz that does not obstruct the UV radiation emanating from at least one UV light source 2705. A high-flow pump 2702 is positioned proximate an inlet port 2710 of the pathway 2701. The pump 2702 is configured to draw surrounding contaminated air through an intake dust filter 2712. The drawn air is then propelled through the pathway 2701 thereby exposing the contaminated air to radiation from the at least one UV light source 2705. Air sterilized by UV light exposure is eventually driven out of the pathway 2701, by the pump 2702, through an outlet port 2715 (FIG. 27A) and into the first chamber 2725. In some embodiments, the intake dust filter 2712 is attached to a flexible, expandable conduit and can be moved away from the outlet port 2715 to create desirable airflow and air exchange.

The UV sterilized air released from the outlet port 2715 circulates in the first chamber 2725 and also flows into the second chamber 2730 via the plurality of openings 2732. UV sterilized air flows through the outflow HEPA filter (residing in the second chamber 2730) via the plurality of openings 2732 before being eventually released outside the enclosure 2720 via the plurality of openings 2735 in the second chamber 2730.

It should be appreciated that the sterilized air released from the outlet port 2715 and into the first chamber 2725 is further exposed to the UV radiation emanating from the at least one UV light source 2705. Additionally, the sterilized air circulating in the first chamber 2725 cools the at least one UV light source 2705 to ambient temperature of about 40+/−5 oC to increase the efficiency of the at least one UV light source 2705.

In some embodiments, the enclosure or chamber 2720 acts as a UV protective casing and, in some embodiments, has a UV reflective lining or paint on its interior to increase effectiveness of the germicidal effect of the UV light. A low-Q Fabry-Perot cavity is created by coating the interior with a reflective material. In some embodiments, the UV reflective lining or paint includes reflective material such as, but not limited to, Germicide or Lumacept Bright.

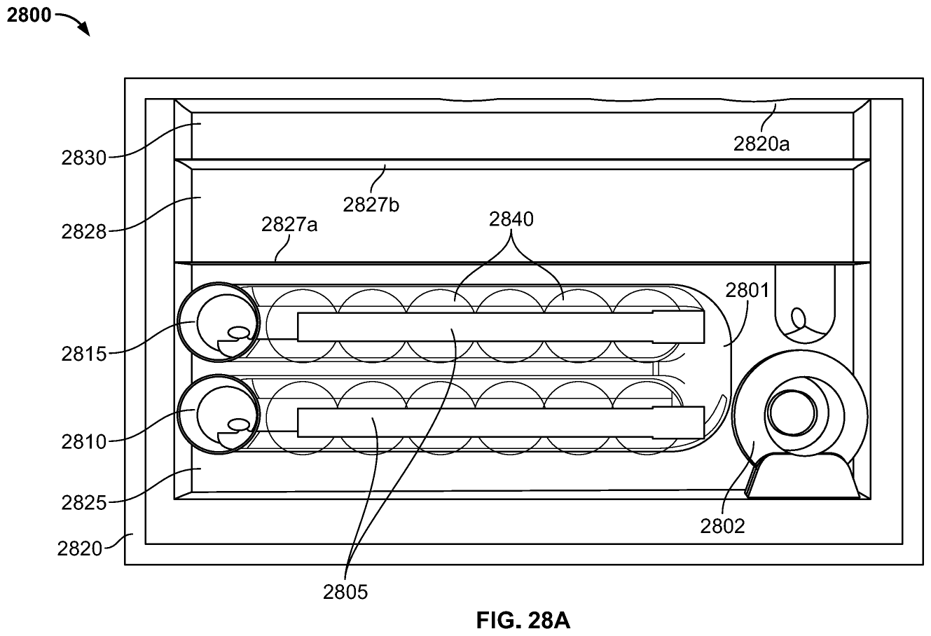

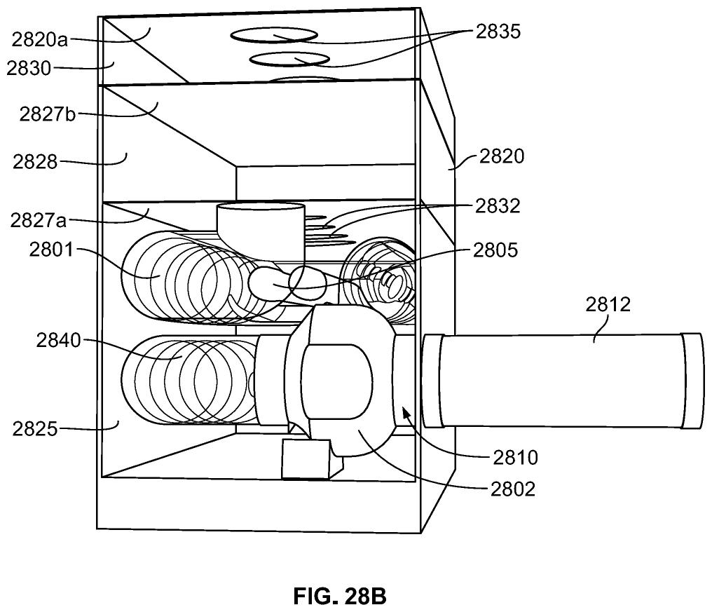

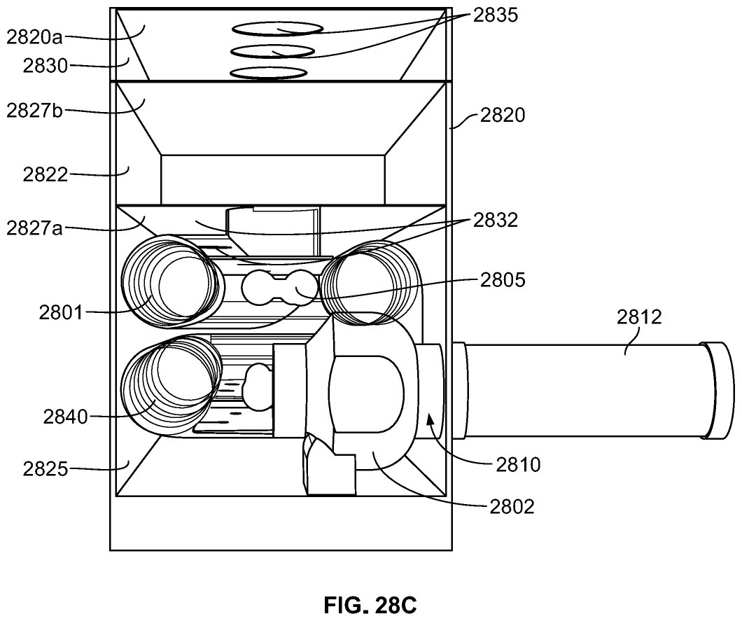

FIGS. 28A, 28B and 28C show first, second and third perspective views of a plurality of components of a room air management system 2800, in accordance with some embodiments of the present specification. Referring now to FIGS. 28A, 28B and 28C, the system 2800 includes a non-linear hollow tube pathway 2801 with a plurality of UV light sources 2805 positioned within the pathway 2801. A plurality of hollow quartz balls or spheres 2840 (similar to the ones described with reference to FIGS. 38 and 47) are positioned within the pathway 2801.

In embodiments, the non-linear hollow tube pathway 2801 with the plurality of UV light sources 2805 is housed within a first chamber 2825 of an enclosure 2820. The enclosure 2820 further includes a second chamber 2828 (above the first chamber 2825) and a third chamber 2830 (above the second chamber 2828). Optionally, an outflow HEPA filter (not shown) is positioned within either one or both of the second chamber 2828 and third chamber 2830 of the enclosure 2820. The first and second chambers 2825, 2828 are separated by a partition 2827a. In some embodiments, the partition 2827 includes a plurality of openings 2832 (FIG. 28B). The second and third chambers 2828, 2830 are also separated by a partition 2827b. A top surface or side 2820a of the third chamber 2830 also includes a plurality of openings 2835 (FIGS. 27B, 27C).

In embodiments, the tube pathway 2801 is of clear quartz that does not obstruct the UV radiation emanating from the plurality of UV light sources 2805. A high-flow pump 2802 is coupled to an inlet port 2810 of the pathway 2801. The pump 2802 is configured to draw surrounding contaminated air through an intake dust filter 2812. The drawn air is then propelled through the pathway 2801 thereby exposing the contaminated air to radiation from the plurality of UV light sources 2805. Air sterilized by UV light exposure is eventually driven out of the pathway 2801, by the pump 2802, through an outlet port 2815 and into the first chamber 2825.

In embodiments, the UV sterilized air released from the outlet port 2815 circulates in the first chamber 2825 and also flows into the second chamber 2830 via the plurality of openings 2832. UV sterilized air flows through the outflow HEPA filter (residing in the second chamber 2830) via the plurality of openings 2832 before being eventually released outside the enclosure 2820 via the plurality of openings 2835 in the third chamber 2830.

It should be appreciated that the sterilized air released from the outlet port 2815 and into the first chamber 2825 is further exposed to the UV radiation emanating from the plurality of UV light sources 2805. Additionally, the sterilized air circulating in the first chamber 2825 cools the at least one UV light source 2805 to ambient temperature of about 40+/−5 oC to increase the efficiency of the plurality of UV light sources 2805.

In some embodiments, the enclosure or chamber 2820 acts as a UV protective casing and, in some embodiments, has a UV reflective lining or paint on its interior to increase effectiveness of the germicidal effect of the UV light. A low-Q Fabry-Perot cavity is created by coating the interior with a reflective material. In some embodiments, the UV reflective lining or paint includes reflective material such as, but not limited to, Germicide or Lumacept Bright.

In some embodiments, a room air management system of the present specification has dimensions ranging from 6 inches, along the smallest side, to 60 inches, along the largest side. In other embodiments, the smallest dimensions may be 9 inches or less than 12 inches; and the largest dimensions may be 50 inches, or 55 inches. The air management system may weigh less than 100 lbs. In some embodiments, the air management system weighs less than 75 lbs, or less than 50 lbs. For different embodiments, the noise level during operation of the air management system is less than 70 dB, less than 65 dB, or less than 50 dB. In embodiments, a unit dwell time for air is less than 1 second. UV-C dose of 0.076 J/cm2 for 0.32 sec is required for 99% inactivation of particulates such as SARS-Cov2 (=0.2375 W/cm2). Therefore, in embodiments, UV-C dose for air is less than 0.05 W/cm².

In embodiments, the air management system of the present specification operates on the centrifugal principle, to generate non-laminar air-flow. The filter uses mechanical filtration methods to filter air with Minimum Efficiency Reporting Value (MERV) of more than 6 at the inlet and more than 12 at the outlet. The destructive filtration method performed by embodiments of the present specification, is dependent on UV radiations and ionization (negative ion/bipolar/cold plasma).

The air management system embodiments of the present specification offer clean air delivery rate (CADR) values of greater than 500 cubic feet per minute (CFM), greater than 750 CFM, or greater than 900 CFM. Based on a test performed in 800 CF aerosol chamber, it was observed that the air management system of the present specification reduced MS-2 bacteriophage (viral surrogate for Covid 19, influenza, and endospores), by greater than 99.99% in less than 15 minutes, and greater than 99.9999% in less than 30 minutes. In the same test, smoke (0.3 to 1.9μ), dust (1 to 3μ), pollen (3 to 10.9μ), and other similar particulates, were reduced by more than 99.99% in less than 15 minutes. Additionally, other airborne pathogens (such as, for example, DNA Viruses (Phi-X174 bacteriophage), Mold Spores (Aspergillus Niger spores), Bacteria (Staphylococcus Epidermis)) were reduced by more than 99.99% in less than 15 minutes, and by more than 99.9999% in less than 30 minutes. Further, greater than 90% reduction in surface pathogens was achieved in less than 120 minutes, and in HCHO in approximately 8 hours.

The above examples are merely illustrative of the many applications of the systems, methods, and apparatuses of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

1. An air cleaning system configured to reduce human exposure to airborne pathogens, comprising:
a housing, wherein the housing is adapted to be hung on a wall at a height from a floor at a base of the wall to a bottom of a housing and wherein the height is in a range of 1.5 feet to 4.5 feet;
an air inlet formed within an exterior surface the housing, wherein the air inlet is formed proximate either a top of the housing or a bottom of the housing;
at least one first filter positioned in the housing behind the air inlet;
an air outlet formed within the housing, wherein the air outlet is formed opposite the air inlet proximate either the bottom of the housing or the top of the housing and wherein the area in the housing between the air inlet and the air outlet forms a central chamber having a left portion, middle portion, and right portion;
at least one second filter positioned in the housing behind the air outlet;
a first fan positioned in the left portion of the central chamber, wherein blades of the first fan are configured to rotate in a vertical plane parallel to the wall;
a second fan positioned in the right portion of the central chamber, wherein blades of the second fan are configured to rotate in a vertical plane parallel to the wall; and
at least one ultraviolet light source positioned within the housing.

2. The air cleaning system of claim 1, wherein the housing has a total thickness defined by a distance between a first exterior surface positioned against the wall and a second exterior surface of the housing running parallel to the wall and wherein the distance is in a range of 4 inches to 12 inches.

3. The air cleaning system of claim 2, wherein a height of the housing is in a range of 18 inches to 60 inches and a width of the housing is in a range of 18 inches to 60 inches.

4. The air cleaning system of claim 3, wherein the air inlet comprises a plurality of openings in the housing and wherein the plurality of openings extend upward from a bottom of the housing and cover no more than 50% of the height of the housing.

5. The air cleaning system of claim 3, wherein the air outlet comprises a plurality of openings in the housing and wherein the plurality of openings extend downward from a top of the housing and cover no more than 50% of the height of the housing.

6. The air cleaning system of claim 1, wherein each of the first fan and the second fan is configured to generate an air flow rate ranging from 100 to 5000 cubic feet per minute.

7. The air cleaning system of claim 1, wherein the blades of the first fan are configured to rotate in a first direction or a second direction and wherein, concurrently, the blades of the second fan are configured to rotate in the same direction or the opposite direction as the first fan.

8. (canceled)

9. (canceled)

10. (canceled)

11. The air cleaning system of claim 1, wherein the at least one first filter positioned in the housing behind the air inlet comprises at least one of a particulate filter, a carbon activated filter, or a photocatalytic filter.

12. The air cleaning system of claim 1, wherein the at least one first filter positioned in the housing behind the air inlet is positioned upstream of each of the first fan and the second fan and comprises a photocatalytic filter, a particulate filter positioned downstream from the photocatalytic filter and a carbon activated filter positioned downstream from the photocatalytic filter.

13. (canceled)

14. The air cleaning system of claim 1, wherein the at least one second filter positioned in the housing behind the air outlet comprises at least one of a particulate filter or a carbon activated filter.

15. The air cleaning system of claim 14, further comprising an ion generator positioned downstream of the at least one particulate filter or the carbon activated filter.

16. The air cleaning system of claim 1, wherein the at least one second filter positioned in the housing behind the air outlet comprises a particulate filter and a carbon activated filter positioned downstream from each of the first fan and the second fan.

17. The air cleaning system of claim 16, wherein an area within the housing, behind the air outlet, and above the central chamber defines a top chamber and wherein the at least one ultraviolet light source is positioned in the top chamber such that air flowing through the top chamber is exposed to ultraviolet light.

18. The air cleaning system of claim 17, wherein an internal surface of the top chamber comprises a reflective surface.

19. The air cleaning system of claim 17, wherein the at least one ultraviolet light source is positioned in the top chamber such that a dose of ultraviolet light being delivered to a surface of the air flowing through the top chamber is greater than a dose of ultraviolet light being delivered to a surface of the particulate filter or the carbon activated filter and wherein an ultraviolet dose for air is less than 0.05 W/cm².

20. (canceled)

21. The air cleaning system of claim 1, wherein at least one of the first fan or the second fan is a backward curved centrifugal fan.

22. The air cleaning system of claim 1, wherein, when operated, the air cleaning system is adapted to purify, sterilize, sanitize, treat, or disinfect air in a room having a volume ranging from 100 to 50,000 cubic feet at an air flow rate ranging from 100 to 3000 cubic feet per minute (CFM), wherein an air exchange rate ranges from 5 to 20 air exchanges per hour and is calculated as 60 times the CFM divided by the volume of the room.

23. The air cleaning system of claim 22, wherein a total weight of the air cleaning system is less than 100 lbs.

24. The air cleaning system of claim 22, wherein a dwell time for air entering the air cleaning system and then leaving the air cleaning system is less than 1 second.

25. The air cleaning system of claim 1 wherein the at least one ultraviolet light source is configured to expose an infected bioaerosol particle in the air with a first dose D1 for a first time T1, and an aerosol particle trapped on at least one of the at least one first filter and the at least one second filter, with a second dose D2 for a second time T2, wherein the first dose D1 is greater the second dose D2, the first time T1 is less that the second time T2, and a first product of the first dose D1 and the first time T1 is less a second product of the second dose D2 and the second time T2.
